(19) United States
(12) Patent Application Publication
(10) Pub. No.: US 2008/0075950 A1
(43) Pub. Date: Mar. 27, 2008

(54) Electron-Conjugated Organic Silane Compound, Functional Organic Thin Film And Production Method Thereof

(76) Inventors: Hiroshi Imada, Nara (JP); Hiroyuki Hanato, Nara (JP); Toshihiro Tamura, Nara (JP)

Correspondence Address: NIXON & VANDERHYE, PC, 901 NORTH GLEBE ROAD, 11TH FLOOR, ARLINGTON, VA, 22203, US

(21) Appl. No.: 11/632,217

(22) PCT Filed: Jul. 28, 2005
(86) PCT No.: PCT/JP05/13817

§ 371 Date: Jan. 11, 2007

(30) Foreign Application Priority Data
Aug. 9, 2004 (JP) 2004-232037
Aug. 9, 2004 (JP) 2004-232038
Aug. 9, 2004 (JP) 2004-232041

(51) Int. Cl. B32B 5/00; C07F 7/08; C07F 7/18

(52) U.S. Cl. 428/333; 549/4; 556/445

(57) ABSTRACT

The present invention provides a highly orientated (crystallized) and highly-densely packed functional organic thin film that can be formed in a simple production method by solution method and adsorb tightly to a surface of a substrate, an organic silane compound for preparation of the thin film, and methods of preparing the same.

An organic silane compound represented by General Formula; A-B—C—SiX¹X²X³ (wherein, A represents a monovalent aliphatic hydrocarbon group having 1 to 30 carbon atoms; B represents an oxygen or sulfur atom; C represents a π-electron-conjugated bivalent organic group; and each of X¹ to X³ represents a group giving a hydroxyl group by hydrolysis). A functional organic thin film obtained by using the organic silane compound.

A method of producing the organic silane compound, comprising introducing an aliphatic hydrocarbon group A onto a compound represented by General Formula; H—C—H (wherein, C is the same as above) via an ether or thioether bond in Williamson reaction, and additionally introducing a silyl group in reaction thereof with a compound represented by General Formula; X⁴—SiX¹X²X³ (wherein, X¹ to X³ are the same as above). A method of producing the functional organic thin film, comprising forming a unimolecular film directly adsorbed on a substrate by hydrolyzing the silyl group in the organic silane compound and allowing the hydrolysate to react with the substrate surface, and washing and removing the unreacted organic silane compound on the unimolecular film with a nonaqueous organic solvent.

### TECHNICAL FIELD

The present invention relates to a π-electron-conjugated organic silane compound, in particular a π-electron-conjugated organic silane compound useful as an electric material, a functional organic thin film using the organic silane compound, and a method of producing the same. Specifically, the present invention relates to a π-electron-conjugated organic silane compound giving a film in which orientation of the molecule therein is controlled by its chemical structure and of which the electroconductive property is thus controllable, a functional organic thin film using the organic silane compound, and a method of producing the same.

### BACKGROUND ART

Recently under progress are research and development on semiconductors of an organic compound (organic semiconductors), because these semiconductors are simpler in production and more compatible with expansion in size of the device than semiconductors of inorganic material, allow cost down by mass production, and have functions wider in variety than those of inorganic materials, and the results by the studies have been reported.

In particular, TFT's (organic thin film transistors) having greater mobility are known to be produced by using an organic compound containing a π-electron-conjugated molecule. A typical example of the organic compound reported is pentacene (for example, Nonpatent Literature 1). The literature discloses that it was possible to prepare a TFT having mobility greater than that of amorphous silicon, specifically an electric-field-effect mobility of 1.5 cm²/Vs, by preparing an organic semiconductor layer of pentacene and forming a TFT with the organic semiconductor layer. However, as described in the literature, production of the organic semiconductor layer demands vacuum processing such as resistance-heated vapor deposition or molecular-beam vapor deposition, making the production process more complicated and giving a crystalline film only under a particular condition. Adsorption of the organic compound film on substrate is only physical adsorption, raising a problem of easy exfoliation of the film because of lower adsorption strength of the film on the substrate. Normally, a film-forming substrate is, for example, previously rubbed for control of the orientation of organic compound molecules in film to some extent, and there is no report that it was possible to control alignment and orientation of physically-adsorbed compound molecules at the interface with the substrate.

Recently on the other hand, self-structured films of an organic compound, which can be produced in a simpler process, are attracting attention from the point of the orientation of film (crystallinity), which exerts a great influence on the electric-field-effect mobility, a typical indicator of TFT characteristics, and, for that reason, studies by using such a film are under progress. The self-structured film is a film in which part of the organic compound is bound to the functional groups on the substrate surface, and also a film having extremely fewer defects and high orientation (crystallinity). Such a self-structured film can be formed on a substrate quite easily, because the production method is quite simple. Normally known as the self-structured films are a thiol film formed on a gold substrate and a silicon compound film formed on a substrate (such as silicon substrate) having hydroxyl groups formed by hydrophilizing finishing that are sticking out of the surface. In particular, silicon compound films are attracting attention, because they have more durable. The silicon compound film has been used as a water-repellent coating film, and is formed by using a silane-coupling agent having an alkyl or fluoroalkyl group higher in water-repellent efficiency as its organic functional group.

The electric conductivity of the self-structured film is determined by the organic functional group in the silicon compound contained in film, but there is no commercially available silane-coupling agent containing a π-electron-conjugated molecule in the organic functional group, and thus, it is difficult to provide the self-structured film with conductivity. Accordingly, there exists a need for a silicon compound suitable for the device such as TFT containing a π-electron-conjugated molecule in its organic functional group.

Compounds having a thiophene ring as the functional group at the molecular terminal, in which the thiophene ring is bound via a straight-chain hydrocarbon group to a silicon atom, were proposed as such silicon compounds (for example, Patent Document 1). Alternatively, polyacetylene films prepared by forming a —Si—O— network on a substrate by chemical adsorption and polymerizing the region of the acetylene groups were also proposed (for example, Patent Document 2). Yet alternatively, proposed were organic devices using, as their semiconductor layer, a conductive thin film that is formed by using a silicon compound, in which a straight-chain hydrocarbon group is bound to the 2 and 5 positions of a thiophene ring and the terminal of the straight-chain hydrocarbon is bound to a silanol group, as the organic material, forming a self-structured film thereof on a substrate, and polymerizing the molecules for example by electrolytic polymerization (for example, Patent Document 3). Yet alternatively, field-effect transistors prepared by using a semiconductor thin film of a silicon compound containing polythiophene, the thiophene ring of which is bound to a silanol group, as the principal component were also proposed (for example, Patent Document 4).

Although it was possible to prepare a self-structured film chemically adsorbable on the substrate with the compounds proposed above, it was not necessarily possible to form an organic thin film superior in orientation (crystallinity), and electroconductive property that could be used in electronic devices such as TFT. In addition, use of the compound proposed above as a semiconductor layer of organic TFT raised a problem of increase in off current. Each of the proposed compounds seems to have bond in the direction perpendicular to the molecular.

There should be high intermolecular attractive force for obtaining high orientation (high crystallinity). The intermolecular force includes attractive and repulsive force factors, and the former factor is inversely proportional to the intermolecular distance to the sixth power, while the latter factor, to the intermolecular distance to the twelfth power. Thus, the intermolecular force, sum of the attractive and repulsive force factors, has the relationship shown in FIG. 7. The minimum point in FIG. 7 (region indicated by an arrow in the Figure) indicates the intermolecular distance at which the intermolecular attractive force in combination of the attractive and repulsive force factors is highest. Accordingly, it is important to make the intermolecular distance as close to the minimum point as possible, to obtain higher crystallinity. For that reason in a vacuum process such as resistance-heated vapor deposition or molecular-beam vapor deposition, it was possible to obtain high orientation (high crystallinity) only under a particular condition by controlling the intermolecular interaction among π-electron-conjugated molecules adequately. It is thus possible to obtain high electroconductive property only by adjusting the crystallinity, based on the intermolecular interaction.

Although the compound above may be chemically adsorbed on a substrate by forming a Si—O—Si two-dimensional network and oriented by intermolecular interaction among particular long-chain alkyl groups, there was a problem that the interaction between molecules is weaker and the length of the π-electron conjugation system essential for electric conductivity is very small, because, for example, only one functional group, a thiophene molecule, contributes to the π-electron conjugation system. Even if it is possible to increase the number of the functional groups, i.e., thiophene molecules, it is still difficult to balance the intermolecular interaction as a factor determining the film orientation between the long-chain alkyl section and the thiophene section.

As for electroconductive property, the functional group, i.e., a thiophene molecule, which has a greater HOMO-LUMO energy gap, had a problem that it did not give sufficiently high carrier mobility, when used as an organic semiconductor layer, for example, of TFT.

For example, conjugation of the n-electron-conjugated unit may be elongated for increase in intermolecular interaction of the π-electron-conjugated units and also for sufficient improvement in carrier mobility. Such units with elongated conjugation include pentacene, oligothiophene with more rings, and the like. However, compounds containing such a π-electron-conjugated unit are less soluble in solvent and give a highly oriented (crystallized) film only under a particular condition. It also demands vacuum processing, causing problems of more complicated production process and high cost.

Known as the processes of forming a film while controlling orientation of organic molecules are a spin coating method and a solution process method of using chemical adsorption. The solution process can reduce the size of the apparatus and also the cost. However, a material should be dissolved in forming a film with the material by the solution method. Materials under current research and deployment for use as an organic device material include π-electron-conjugated compounds, such as oligothiophenes and pentacene, monocyclic heterocyclic aromatic and heterocyclic compounds, and the like, but these materials are less soluble in solvent and soluble in a limited number of solvents.

To overcome the problem above, prepared were many monocyclic and heterocyclic aromatic and heterocyclic compounds having a straight-chain hydrocarbon group, such as a halogen atom-substituted or unsubstituted alkyl group, directly introduced. Introduction of a hydrophobic substituent or an end group allows improvement in solubility in solvent.

Nonpatent Literature 1: IEEE Electron Device Lett., 18, 606-608 (1997)

Patent Document 1: Japanese Patent No. 2889768

Patent Document 2: Japanese Examined Patent Publication No. 6-27140

Patent Document 3: Japanese Patent No. 2507153

Patent Document 4: Japanese Patent No. 2725587

### DISCLOSURE OF THE INVENTION

### Technical Problems to be Solved

However, when the hydrocarbon group is introduced directly into the compound, orientation of the π-electron-conjugated region and the distance between neighboring molecules, which govern the electrical properties, are placed under the influence by orientation of the hydrocarbon group.

For example, introduction of a hydrocarbon group having approximately 15 or fewer carbon atoms leads to aggregation or relatively random orientation in the hydrocarbon group region, making the region more amorphous. When the hydrocarbon group region is amorphous, the molecules in the hydrocarbon group region are more active in movement, i.e., migration, revolution, and vibration, resulting in deterioration in orientation of the π-electron-conjugated region to which the hydrocarbon group region is bound directly, and also, in relative expansion of the distance between neighboring molecules and deterioration in electroconductive property of the film obtained.

Alternatively, for example, when a hydrocarbon group having approximately 16 or more carbon atoms is introduced, orientation in the hydrocarbon group region and π-electron-conjugated region may be improved to some extent, but the π-electron-conjugated region is only oriented to the degree corresponding to that of the hydrocarbon group region, under the influence by the hydrocarbon group region. In particular, when the hydrocarbon group has a greater chain length, the hydrocarbon group regions become oriented more easily and the orientation (crystallization) speed of the hydrocarbon group region becomes greater than that of the π-electron-conjugated region, and thus, orientation of the π-electron conjugate region depends more on that of the hydrocarbon group region. As a result, it also leads to relative widening of the distance between neighboring molecules and deterioration in electroconductive property of the film obtained.

Thus, it is essential that the structure in the π-electron-conjugated region is not disturbed by the introduced substituent group, to make the π-electron-conjugated region have a structure suitable for electric conduction, i.e., a structure higher in orientation (crystallinity) and smaller in the distance between neighboring molecules.

An object of the present invention, which was made under the circumstances above, is to provide a π-electron-conjugated organic silane compound for preparation of a highly orientated (crystallized), highly-densely packed thin film superior electroconductive property that can be formed by crystallization in a simple production method by solution method and is resistant to physical exfoliation because of tight adsorption of the thin film on the substrate surface, and a method of producing the same.

Another object of the present invention is to provide a new π-electron-conjugated organic silane compound showing sufficiently high carrier mobility when used in a semiconductor electronic device such as TFT, and a method of producing the same.

Yet another object of the present invention is to provide a highly orientated (crystallized), highly-densely packed functional organic thin film that can be formed in a simple production method by solution method and is resistant to physical exfoliation because of tight adsorption of the thin film on the substrate surface, and a method of producing the same.

Yet another object of the present invention is to provide a functional organic thin film showing sufficiently high carrier mobility when used in a semiconductor electronic device such as TFT and a method of producing the same and a method of producing the same.

In the present description, the high-density packed state means a state allowing shortening of the distance between neighboring molecules, in particular the distance between π-electron-conjugated regions, during film forming and consequently, allowing orientation of the compound molecules at a relatively higher density.

### Means to Solve the Problems

The present invention relates to a π-electron-conjugated organic silane compound represented by General Formula (I);
A-B—C—SiX¹X²X³ (I)
(wherein, A represents a monovalent aliphatic hydrocarbon group having 1 to 30 carbon atoms of which the hydrogen atoms may be replaced with halogen atoms; B represents an oxygen or sulfur atom; C represents a π-electron-conjugated bivalent organic group; and each of X¹ to X³ represents a group giving a hydroxyl group by hydrolysis).

The present invention also relates to a method of producing the π-electron-conjugated organic silane compound above, comprising introducing a monovalent aliphatic hydrocarbon group A into a molecule containing a π-electron-conjugated skeleton represented by General Formula (III):
H—C—H (III)
(wherein, C represents a π-electron-conjugated bivalent organic group) via an ether or thioether bond in Williamson reaction, and additionally introducing a silyl group in reaction with a compound represented by General Formula (IV):
X⁴—SiX¹X²X³ (IV)
(wherein, each of X¹ to X³ represents a group giving a hydroxyl group by hydrolysis; and X⁴ represents a hydrogen or halogen atom or a lower alkoxy group).

The present invention also relates to a functional organic thin film, comprising an unimolecular film prepared by using the π-electron-conjugated organic silane compound represented by General Formula (I) above.

The present invention also relates to a method of producing a functional organic thin film, comprising forming a unimolecular film directly adsorbed on a substrate by hydrolyzing the silyl group in a π-electron-conjugated organic silane compound represented by General Formula (I) and allowing the hydrolysate to react with the substrate surface, and washing and removing the unreacted organic silane compound on the unimolecular film with a nonaqueous organic solvent.

### EFFECT OF THE INVENTION

The π-electron-conjugated organic silane compound according to the present invention expands the orientation direction of bonds, by allowing its aliphatic hydrocarbon group to bind to a π-electron-conjugated molecule via an ether or thioether bond. Thus, introduction of the aliphatic hydrocarbon group secures the orientation (crystallinity) and high-density packing characteristics most suitable for carrier movement in the π-electron-conjugated region in film, without breakdown of the stable crystal structure in the π-electron-conjugated region.

The organic silane compound according to the present invention is adsorbed chemically on a substrate by the silyl group-derived Si—O—Si two-dimensional network formed between the compounds, and gives a highly crystallized and highly packed thin film with very high stability, because the intermolecular interaction (force attracting molecules closer) needed for high crystallization and high-density packing of the film become more efficient. Consequently, carrier movement becomes smoother, by favorable hopping conduction between the compound molecules. Such a film has high electroconductivity also in the molecular-axis direction. Accordingly, the film may be used as a conductive material, specifically as an organic thin film transistor material, and also in various devices such as solar battery, fuel cell, and sensor. It is more resistant to physical exfoliation than a film prepared on a substrate by physical adsorption, because the film is more tightly bound to the substrate surface.

The organic silane compound according to the present invention, which has an aliphatic hydrocarbon group as hydrophobic group, is more soluble in non-aqueous solvent. Thus, it is possible to use a relatively simple solution method, for example, in forming a thin film. In addition, the organic silane compound according to the present invention can be produced easily in a simple process.

### BRIEF DESCRIPTION OF THE DRAWINGS

FIG. 1(A) is a schematic view illustrating orientation of the compound molecules in the thin film obtained by using a π-electron-conjugated organic silane compound according to the present invention (B: oxygen atom); and FIG. 1(B) is a schematic view illustrating orientation of the compound molecules in the thin film obtained by using a conventional π-electron-conjugated organic silane compound (B: oxygen atom).

FIG. 2 is a graph showing a surface pressure-molecular area curve of the terphenyl derivative 1A obtained in Preparative Example 1 and the terphenyl derivative 1B obtained in Comparative Preparative Example 1.

FIG. 3 is a graph showing a surface pressure-molecular area curve of the quaterthiophene derivative 2A obtained in Preparative Example 2 and the quaterthiophene derivative 2B obtained in Comparative Preparative Example 3.

FIG. 4 is a schematic configuration view illustrating an organic thin film transistor prepared in Examples.

FIG. 5 is a graph showing the properties of the organic thin film transistor prepared by using the quaterthiophene derivative 3A obtained in Preparative Example 3.

FIG. 6 is a graph showing the properties of the organic thin film transistor prepared by using the quaterthiophene derivative 3B obtained in Comparative Preparative Example 5.

FIG. 7 is a chart showing the relationship between the intermolecular distance and the potential energy.

### EXPLANATION OF REFERENCES

10: Silicon substrate, 12: Organic semiconductor layer, 13: Source electrode, 14: Drain electrode, 15: Gate electrode, and 16: Insulation film.

### BEST MODE FOR CARRYING OUT THE INVENTION

(Organic Silane Compound)

The π-electron-conjugated organic silane compound according to the present invention is represented by General Formula (I);
A-B—C—SiX¹X²X³ (I).
Hereinafter, the compound will be called an organic silane compound (I).

In Formula (I), A represents a monovalent aliphatic hydrocarbon group having 1 to 30 carbon atoms.

The aliphatic hydrocarbon group A may be a straight- or branched-chain group, but is preferably a straight-chain group from the viewpoints of orientation and high-density packing of the film.

One or more hydrogen atoms in the aliphatic hydrocarbon group A may be replaced with a halogen atom such as fluorine, chlorine, bromine, or iodine, preferably fluorine.

The aliphatic hydrocarbon group A may be unsaturated or saturated, but is preferably a saturated aliphatic hydrocarbon group.

Favorable examples of the aliphatic hydrocarbon groups A are alkyl groups having the carbon number described above. Typical favorable examples thereof include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl and triacontyl groups, and one or more hydrogen atoms in the group may be replaced with a halogen atom.

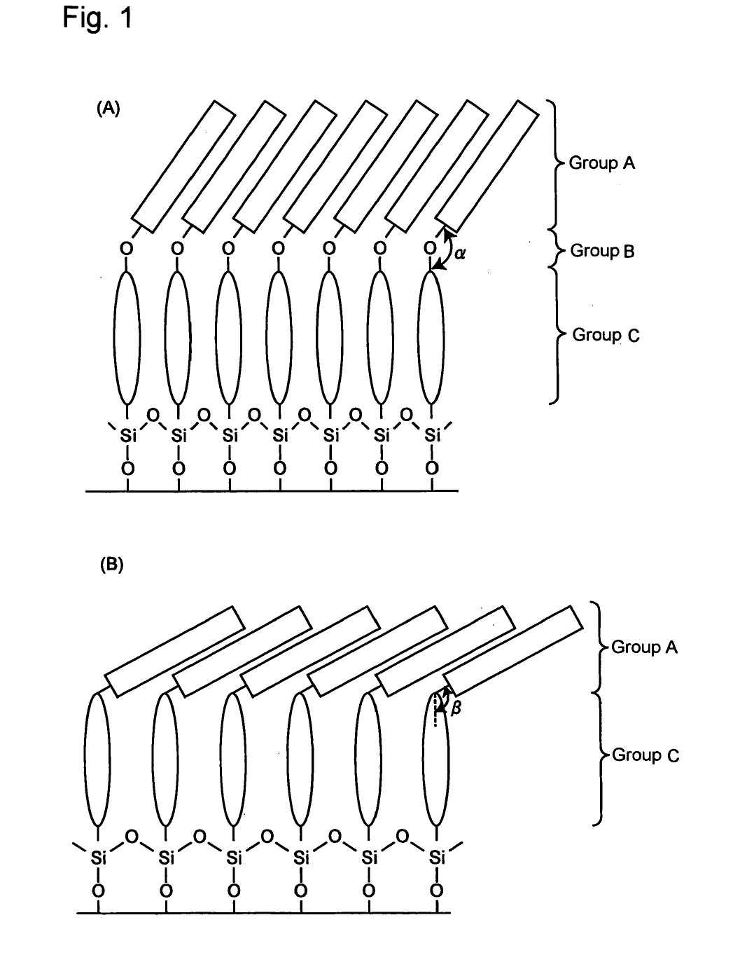

In Formula (I), B represents an oxygen or sulfur atom. As shown in a schematic view (FIG. 1(A)) illustrating orientation of the compound molecule in the thin film obtained by using a organic silane compound (I) according to the present invention (B: oxygen atom), it is possible to increase the binding angle (α) of the organic group C (π-electron-conjugated region) with respect to the hydrocarbon group A by introducing the hydrocarbon group A via a group B (oxygen atom (ether bond) or sulfur atom (thioether bond)). The binding angle of C—O—C or C—S—C bond is greater than that of the C—C—C bond. Thus, orientation of the organic group C is less influenced by orientation of the hydrocarbon group A.

For example, when the hydrocarbon group A has a carbon number of 16 or more (13 or more if the hydrocarbon group A is substituted with halogen atoms), it is possible to avoid the adverse effect of orientation of the hydrocarbon group A on orientation of the organic group C and minimize the distance between neighboring molecules in the oriented structure of the organic groups C, leading to improvement in packing density and restriction of turbulence in the structure. Alternatively for example when the hydrocarbon group A has a carbon number of 1 to 15 (1 to 12 if the hydrocarbon group A is substituted with halogen atoms), it is possible to minimize the distance between neighboring molecules in the oriented structure of the organic groups C even if the hydrocarbon group A is aggregated or randomly oriented, leading to important high-density packing and restriction of the turbulence in the structure.

On the other hand, when the hydrocarbon group A is introduced directly into the organic group C without a group B as shown in FIG. 1(B), orientation of the organic group C is more influenced by orientation of the hydrocarbon group A, because the binding angle (β) of the organic group C with respect to the hydrocarbon group A is relatively smaller, leading to elongation of the distance between neighboring molecules in the oriented structure of the organic groups C and consequently to deterioration in packing density and generation of turbulence in the structure.

In Formula (I), C is not particularly limited, if it is a π-electron-conjugated bivalent organic group, i.e., a residue of a molecule containing a π-electron-conjugated skeleton (π-electron-conjugated skeleton) from which two hydrogen atoms are eliminated. The π-electron conjugation means that, by having one or more bonds formed by one a bond and one πbond, the π-electron in the πbond is delocalized. Increase in size of the π-electron-delocalized molecule leads to increase in the moving distance of the π-electron, and thus, to improvement in the electroconductive property of the thin film obtained and the carrier mobility when such a compound is used in a semiconductor electronic device such as TFT.

Such an organic group C contains one or more units selected from the group consisting of monocyclic aromatic ring units, fused aromatic ring units, monocyclic aromatic heterocyclic units, fused aromatic heterocyclic units, and unsaturated aliphatic units, and may be a straight- or branched-chain group. The organic group C is preferably a straight-chain from the viewpoints of orientation and high-density packing of the film.

Typical examples of each unit will be described below, and the binding site of each unit, i.e. the binding site of an unit with respect to the other unit, group B or silyl group (—SiX¹X²X³) is not particularly limited. For example when the unit is a monocyclic aromatic five-membered heterocyclic unit, the binding site may be 2,5-, 3,4-, 2,3-, 2,4-, or other position, and, among them, 2,5-position is preferable, for further improvement of the orientation and high-density packing of the film. Alternatively for example when the unit is monocyclic aromatic six-membered ring unit or monocyclic aromatic six-membered heterocyclic unit, the binding site may be 1,4-, 1,2-, 1,3-, or other position, and, among them, 1,4-position is preferable, for further improvement of the orientation and high-density packing of the film. The binding site is expressed with respect to the hetero atom when the ring has one hetero atom, to the hetero atom having the largest molecular weight when the ring has two or more hetero atoms, and to any carbon atom when the ring has no hetero atom. Alternatively for example when the unit is a fused aromatic ring unit or fused aromatic heterocyclic unit having point symmetry, the binding sites at which the line connecting them passes on the center point of the point symmetry are preferable. Alternatively for example when the unit is a fused aromatic ring unit or fused aromatic heterocyclic unit having axisymmetry, the binding sites at which the line connecting them passes on the midpoint of the centerline of axisymmetry are preferable. Units having two binding sites are described so far, but, when the unit has three or more binding sites, at least two of the binding sites are preferably located as described above and, in such a case, the other one or more binding sites are not particularly limited.

A typical example of the monocyclic aromatic ring unit is benzene.

Typical examples of the fused aromatic ring units include the acene series compounds represented by General Formula (II); 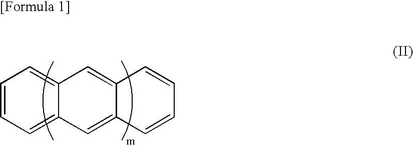
(wherein, m is an integer of 0 to 10), phene series compounds, peri-fused ring compounds, azulene, fluorene, anthraquinone, acenaphthylene and the like. Examples of the acene series compounds include naphthalene, anthracene, naphthacene, pyrene, pentacene, and the like. Examples of the phene series compounds include phenanthrene, benz[a]anthracene, and the like. Examples of the peri-fused ring compounds include perylene and the like. Favorable fused aromatic ring units are acene series compounds.

Typical examples of the monocyclic aromatic heterocyclic units include the following units:

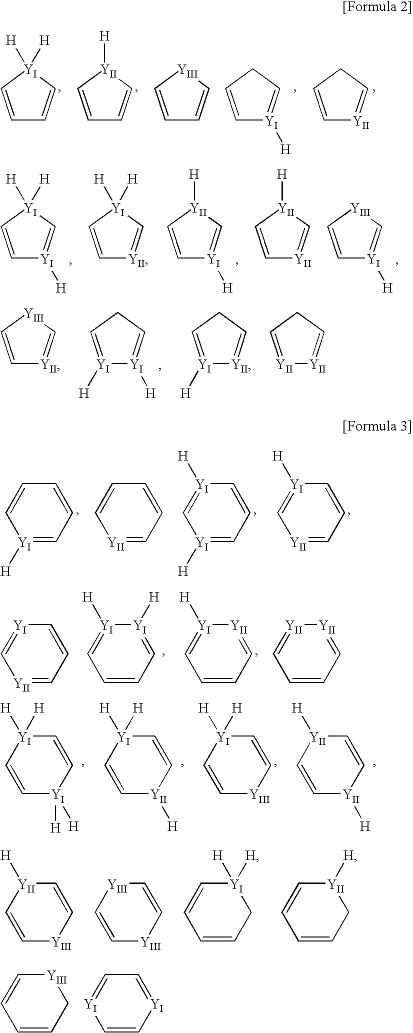

In the typical examples above, Y_{I} is in common a hetero atom in the 4A or 4B group element for example, such as Si, Ge, Sn, Ti or Zr.

Y_{II} xis in common a hetero atom in the 5B group element for example, such as N or P.

Y_{III} is in common a hetero atom in the 6B group element for example, such as O, S, Se or Te.

When two or more pieces of a kind of Y group selected from Y_{I}, Y_{II}, and Y_{III} is present in one unit, each of the Y group is selected independently in the range above.

Typical favorable examples of the monocyclic aromatic heterocyclic units include thiophene, furan, pyrrole, oxazole, imidazole, silole, selenophene, pyridine, pyrimidine, and the like. A particularly preferable monocyclic aromatic heterocyclic unit is thiophene.

The fused aromatic heterocyclic unit is a fused compound of the monocyclic aromatic heterocyclic units or a fused compound of the monocyclic aromatic heterocyclic unit and the monocyclic aromatic ring unit. Typical examples of the fused aromatic heterocyclic units include benzothiophene, benzoxazine, and the like.

The unsaturated aliphatic units include alkenes, alkadienes, and alkatrienes. The alkene is preferably an alkene having 2 to 4 carbon atoms such as ethylene, propylene, or butene. The alkadiene is preferably an alkadiene having 4 to 6 carbon atoms such as butadiene, pentadiene, or hexadiene. The alkatriene is preferably an alkatriene having 6 to 8 carbon atoms such as hexatriene, heptatriene, or octatriene.

When the organic group C is a straight-chain group, the unit forms an organic group C as a bivalent group with two hydrogen atoms therein being eliminated, while, when the organic group C is a branched group containing the branching point for the branched organic group C, the unit for the branching point forms the organic group C as a trivalent or higher group with three or more hydrogen atoms being eliminated.

The organic group C preferably has one or more units selected from the group consisting of monocyclic aromatic ring units, fused aromatic ring units and monocyclic aromatic heterocyclic units from the viewpoint of interaction among the organic groups C.

The organic group C preferably contains a fused aromatic ring unit, a monocyclic aromatic five-membered heterocyclic unit or a fused aromatic heterocyclic unit, from the viewpoint of effectiveness of the present invention. Such a unit having a five-membered or fused ring loses its molecular symmetry easily, and thus, conventional introduction of a hydrocarbon group A directly into the organic group C often results in deterioration in packing density and increase in orientation turbulence in the orientation structure of the organic groups C in thin film, but in the present invention, it is possible to prevent deterioration in packing density and turbulence in orientation effectively, by introducing an ether or thioether bond even if the organic group C contains such a unit.

The number of the units constituting the organic group C is not particularly limited, but preferably 1 to 30, particularly preferably 1 to 10 from the viewpoint of yield. It is preferably 1 to 8 from the viewpoints of cost and mass productivity.

When the number of the units constituting the organic group C is 2 or more, all units may be the same as each other, or alternatively, part or all of the units may be different from each other.

When the organic group C contains multiple kinds of units, the multiple kinds of units may be bound to each other, as they are orderly oriented with a particular recurring unit or randomly oriented.

The organic group C may be substituted, as far as the orientation (crystallinity) and high-density packing of the film obtained is not disturbed. Examples of the substituent groups include a hydroxyl group, alkyl groups, alkenyl groups, aralkyl groups, a carboxyl group, and the like. The substituent group may be further substituted with a halogen atom such as fluorine, chlorine, bromine or iodine.

The alkyl group is preferably a group having 1 to 3 carbon atoms such as methyl, ethyl, or propyl group.

The alkenyl group is preferably a group having 2 to 3 carbon atoms such as vinyl or allyl.

The aralkyl group is preferably a group having 7 to 8 carbon atoms such as benzyl or phenethyl.

In Formula (I), X¹ to X³ each represent a group giving a hydroxyl group by hydrolysis. The group giving a hydroxyl group by hydrolysis is not particularly limited, and examples thereof include halogen atoms, lower alkoxy groups, and the like. Examples of the halogen atoms include fluorine, chlorine, iodine, and bromine. Examples of the lower alkoxy groups include alkoxy groups having 1 to 4 carbon atoms. Typical examples thereof include methoxy, ethoxy, n-propoxy, 2-propoxy, n-butoxy, sec-butoxy, and tert-butoxy groups and the like; and part of such a group may be substituted with yet another functional group (such as trialkylsilyl or another alkoxy). X¹, X² and X³ may be the same as each other, or alternatively, part or all of them may be different from each other, but all of them are preferably the same.

The organic silane compounds (I) may be grouped into organic silane compounds (Ia) represented by the following General Formula (Ia) and organic silane compounds (Ib) represented by the following General Formula (Ib), from viewpoint of the efficiency in improving packing density.
A^{a}-B—C—SiX¹X²X³ (Ia)
(in Formula (Ia), A^{a} represents a monovalent aliphatic hydrocarbon group, of which the hydrogen atoms may be replaced with halogen atoms, that has 1 to 15 carbon atoms, preferably 1 to 10 carbon atoms when it is not substituted with halogen atoms, or that has 1 to 12 carbon atoms when it is substituted with a halogen atom; specifically, A^{a} is the same as A in General Formula (I), except that the number of carbons is in the range above, depending on the presence or absence of halogen atoms; and B, C and X¹ to X³ are the same as those in General Formula (I)).
A^{b}-B—C—SiX¹X²X³ (Ib)
(in Formula (Ib), A^{b} represents a monovalent aliphatic hydrocarbon group, of which the hydrogen atoms may be replaced with halogen atoms, that has 16 to 30 carbon atoms, preferably 16 to 24 carbon atoms when it is not substituted with halogen atoms, or that has 13 to 25 carbon atoms, preferably 13 to 20 carbon atoms, when it is substituted with a halogen atom; specifically, A^{b} is the same as A in General Formula (I), except that the number of carbons is in the range above, depending on the presence or absence of halogen atoms; and B, C and X¹ to X³ are the same as those in General Formula (I)).

Typical examples of the organic silane compounds (I) above include the compounds represented by the following General Formulae (1) to (14).

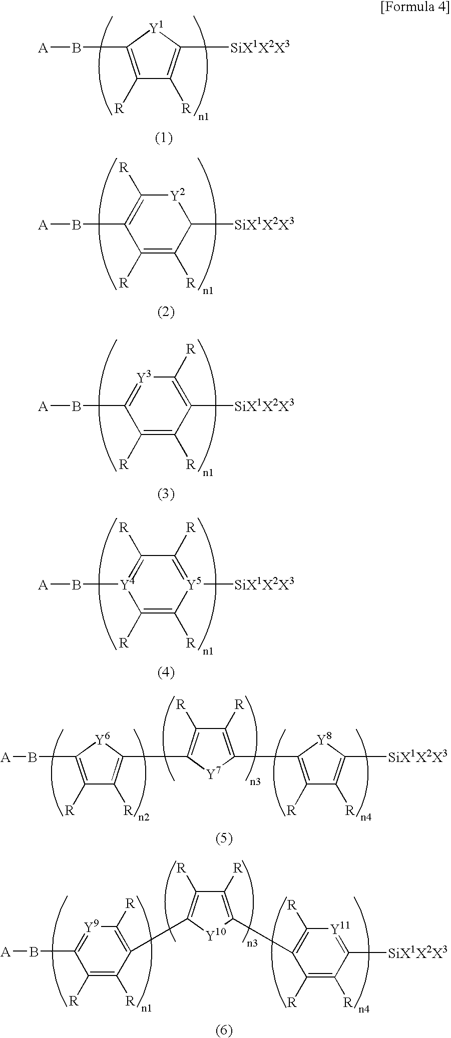

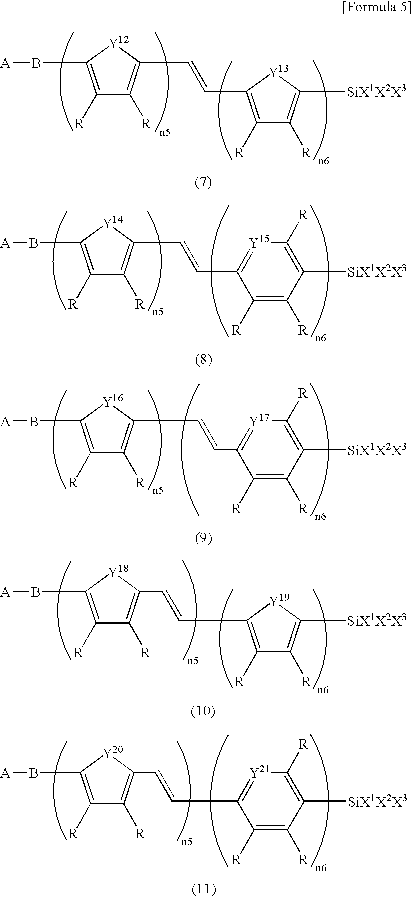

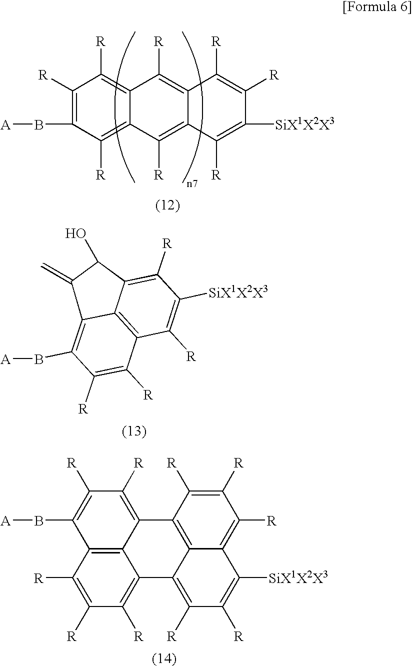

The following groups and symbols common in General Formulae (1) to (14) are the same as each other.

A, B and X¹ to X³ are respectively the same as those in Formula (I).

R represents a hydrogen atom, a hydroxyl group, an alkyl group having 1 to 3 carbon atoms, an alkenyl group having 2 to 3 carbon atoms, an aralkyl group having 7 to 8 carbon atoms, or a carboxyl group, preferably a hydrogen atom or an alkyl group having 1 to 3 carbon atoms. When there are multiple groups R in each General Formula, each group R is selected independently from the range above.

The other groups and symbols used will be described below separately in each Formula.

In General Formula (1), Y¹ represents N, O, S, Si, Ge, Se, Te, P, Sn, Ti or Zr, preferably S. Specifically, when Y¹ is Si, Ge, Sn, Ti, or Zr, it is —Y¹ (R¹)₂—; when Y¹ is N or P, it is —Y¹(R₁)—; and when Y¹ is O, S, Se, or Te, it is —Y¹—. R¹ is a hydrogen atom or a methyl, ethyl, n-propyl, 2-propyl, n-butyl, sec-butyl, tert-butyl, or phenyl group, preferably a hydrogen atom or a methyl group. n1 is an integer of 1 to 30, preferably of 1 to 8.

In General Formula (2), Y² represents O, S, Se or Te, preferably S. Specifically, when Y² is O, S, Se, or Te, it is —Y¹—. n1 is an integer of 1 to 30, preferably of 1 to 8.

In General Formula (3), Y³ represents C, N, Si, Ge, P, Sn, Ti or Zr, preferably C. Specifically, when Y³ is C, Si, Ge, Sn, Ti, or Zr, it is —Y³ (R¹)═; and when Y³ is N or P, it is —Y³═. R¹ is the same as that in Formula (1) and preferably a hydrogen atom or a methyl group.

n1 is an integer of 1 to 30, preferably of 1 to 8.

In General Formula (4), Y⁴ and Y⁵ each independently represent C, Si, Ge, Sn, Ti or Zr, preferably Si or Ge (however, Y⁴ and Y⁵ are not C at the same time). n1 is an integer of 1 to 30, preferably of 1 to 8.

In General Formula (5), Y⁶ to Y⁸ each independently represent S, N, O, Si, Ge, Se, Te, P, Sn, Ti or Zr (however, Y⁶ to Y⁸ are not the same atom). Specifically, when Y⁶ is C, Si, Ge, Sn, Ti, or Zr, it is —Y⁶ (R¹)₂—; when Y⁶ is N or P, it is —Y⁶ (R¹)—; and when Y⁶ is S, O, Se, or Te, it is —Y⁶—. R¹ is the same as that in Formula (1) and preferably a hydrogen atom or a methyl group. Specific examples of Y⁷ and Y⁸ are the same as those of Y⁶.

n2+n3+n4 is an integer of 3 to 30. However, n2 is 1 or more; n3 is 1 or more; and n4 is 1 or more.

In General Formula (6), Y¹⁰ represents N, O, S, Si, Ge, Se, Te, P, Sn, Ti or Zr. Specifically, when Y¹⁰ is Si, Ge, Sn, Ti, or Zr, it is —Y¹⁰ (R¹)₂—; when Y¹⁰ is N or P, it is —Y¹⁰ (R¹)—; and when Y¹⁰ is O, S, Se, or Te, it is —Y¹⁰—. R¹ is the same as that in Formula (1) and preferably a hydrogen atom or a methyl group.

Y⁹ and Y¹¹ each independently represent N, C, Si, Ge, P, Sn, Ti or Zr. Specifically, when Y⁹ is C, Si, Ge, Sn, Ti, or Zr, it is —Y⁹(R¹)═; and when Y⁹ is N or P, it is —Y⁹═. R¹ is the same as that in Formula (1) and preferably a hydrogen atom or a methyl group. Specific examples of Y¹¹ are the same as those of Y⁹.

n2+n3+n4 is an integer of 3 to 30. However, n2 is 1 or more; n3 is 1 or more; and n4 is 1 or more.

In General Formula (7), Y¹² to Y¹³ each independently represent S, N, O, Si, Ge, Se, Te, P, Sn, Ti or Zr. Specifically, when Y¹² is Si, Ge, Sn, Ti, or Zr, it is —Y¹² (R¹)₂—; when Y¹² is N or P, it is —Y¹² (R¹)—; when Y¹² is S, O, Se, or Te, it is —Y¹²—. R¹ is the same as that in Formula (1) and preferably a hydrogen atom or a methyl group. Specific examples of Y¹³ are the same as those of Y¹².

n5+n6 is an integer of 2 to 30, preferably 2 to 8. However, n5 is 1 or more, and n6 is 1 or more.

In General Formula (8), Y¹⁴ represents S, N, O, Si, Ge, Se, Te, P, Sn, Ti or Zr. Specifically, when Y¹⁴ is Si, Ge, Sn, Ti, or Zr, it is —Y¹⁴ (R¹)₂—; when Y¹⁴ is N or P, it is —Y¹⁴ (R¹)—; and when Y¹⁴ is S, O, Se, or Te, it is —Y¹⁴—. R¹ is the same as that in Formula (1) and preferably a hydrogen atom or a methyl group.

Y¹⁵ represents N, C, Si, Ge, P, Sn, Ti or Zr. Specifically, when Y¹⁵ is C, Si, Ge, Sn, Ti, or Zr, it is —Y¹⁵(R¹)═; and when Y¹⁵ is N or P, it is —Y¹⁵═. R¹ is the same as that in Formula (1) and preferably a hydrogen atom or a methyl group.

n5+n6 is an integer of 2 to 30, preferably 2 to 8. However, n5 is 1 or more, and n6 is 1 or more.

In General Formula (9), Y¹⁶ represents S, N, O, Si, Ge, Se, Te, P, Sn, Ti or Zr. Specifically, when Y¹⁶ is Si, Ge, Sn, Ti, or Zr, it is —Y¹⁶ (R¹)₂—; when Y¹⁶ is N or P, it is Y¹⁶ (R¹)—; and, when Y¹⁶ is S, O, Se, or Te, it is —Y¹⁶—. R¹ is the same as that in Formula (1) and preferably a hydrogen atom or a methyl group.

Y¹⁷ represents N, C, Si, Ge, P, Sn, Ti or Zr. Specifically, when Y¹⁷ is C, Si, Ge, Sn, Ti, or Zr, it is —Y¹⁷(R¹)═; and, when Y¹⁷ is N or P, it is —Y¹⁷═. R¹ is the same as that in Formula (1) and preferably a hydrogen atom or a methyl group.

n5+n6 is an integer of 2 to 30, preferably 2 to 8. However, n5 is 1 or more, and n6 is 1 or more.

In General Formula (10), Y¹⁸ to Y¹⁹ each independently represent S, N, O, Si, Ge, Se, Te, P, Sn, Ti or Zr. Specifically, when Y¹⁸ is Si, Ge, Sn, Ti, or Zr, it is —Y¹⁸ (R¹)₂—; when Y¹⁸ is N or P, it is —Y¹⁸ (R¹)—; and, when Y¹⁸ is S, O, Se, or Te, it is —Y¹⁸—. R¹ is the same as that in Formula (1) and preferably a hydrogen atom or a methyl group. Specific examples of Y¹⁹ are the same as those of Y¹⁸.

n5+n6 is an integer of 2 to 30, preferably 2 to 8. However, n5 is 1 or more, and n6 is 1 or more.

In General Formula (11), Y²⁰ represents S, N, O, Si, Ge, Se, Te, P, Sn, Ti or Zr. Specifically, when Y²⁰ is Si, Ge, Sn, Ti, or Zr, it is —Y²⁰ (R¹)₂—; when Y²⁰ is N or P, it is —Y²⁰(R¹)—; and, when Y²⁰ is S, O, Se, or Te, it is —Y²⁰—. R¹ is the same as that in Formula (1) and preferably a hydrogen atom or a methyl group.

Y²¹ represents N, C, Si, Ge, P, Sn, Ti or Zr. Specifically,

when Y²¹ is C, Si, Ge, Sn, Ti, or Zr, it is —Y²¹ (R¹)═; and, when Y²¹ is N or P, it is —Y²=. R¹ is the same as that in Formula (1) and preferably a hydrogen atom or a methyl group.

n5+n6 is an integer of 2 to 30, preferably 2 to 8. However, n5 is 1 or more, and n6 is 1 or more.

In General Formula (12), n7 is an integer of 1 to 28, preferably 1 to 8.

(Synthetic Method)

Hereinafter, the method of preparing the organic silane compound (I) according to the present invention will be described, with reference to typical examples (synthetic routs 1 to 3) below.

A monovalent aliphatic hydrocarbon group A is first introduced into a molecule containing a π-electron-conjugated skeleton represented by General Formula (III);
H—C—H (III)
(wherein, C is the same as the organic group C in Formula (1) above) via an ether bond (—O—) or a thioether bond (—S—) in Williamson reaction.

In the Williamson reaction, a monovalent aliphatic hydrocarbon group A is introduced into the molecule containing a π-electron-conjugated skeleton via an ether bond, by introducing a hydroxyl group previously into a particular site of the molecule containing a π-electron-conjugated skeleton and allowing the hydroxyl compound to react with a monohalogenated alkane or an alkyl sulfonate ester containing a particular monovalent aliphatic hydrocarbon group A in the presence of sodium hydroxide, purified water, and others (see, for example, first to third reaction formulae in synthetic route 1 and first to second reaction formulae in synthetic route 3). For example, the molecule containing a π-electron-conjugated skeleton is dissolved in a solution of n-chlorosuccinimide, chloroform, and acetic acid, allowing chlorination of the terminal hydrogen in reaction, and the solution in flask is stirred under a nitrogen environment, to give a chlorinated compound of the molecule containing a π-electron-conjugated skeleton. The chlorinated compound is then dissolved in a solution of sodium carbonate and sodium hydroxide in tetrahydrofuran (THF), and the mixture is mixed with an excess amount of purified water. The solution is allowed to react at 100 to 110° C., to hydrolyze the chlorinated terminal. The hydroxyl compound is allowed to react in a solution of n-alkyl bromide and sodium hydroxide in THF and purified water, etherifying the hydroxyl group in the Williamson synthetic reaction.

Thioetherification can be performed by a method similar to the etherification reaction described above. Alkylation of an alkylthiol in the presence of a hydroxide ion base such as sodium hydroxide gives the thioether. The base generates an alkane thiolate ion, which in turn reacts with the haloalkane. In the present invention, for example, the molecule containing a π-electron-conjugated skeleton is dissolved in a solution of n-chlorosuccinimide, chloroform, and acetic acid for chlorination of the terminal hydrogen atom and the solution in flask is stirred under a nitrogen environment, to give a chlorinated compound of the molecule containing a π-electron-conjugated skeleton. The chlorinated compound is dissolved in a solution of alkanethiol, sodium carbonate, and sodium hydroxide in tetrahydrofuran (THF). Reaction of the solution at 110° C. results in thioetherification of the chlorinated terminals.

A silyl group is then introduced by reaction with a silane compound represented by General Formula (IV):
X¹—SiX¹X²X³ (IV)
(wherein, X¹, X² and X³ are the same as those in Formula (1); X⁴ represents a hydrogen or halogen atom (for example, fluorine, chlorine, iodine or bromine) or a lower alkoxy group (for example, methoxy, ethoxy, n-propoxy, 2-propoxy, n-butoxy, sec-butoxy, tert-butoxy, or the like)).

In the reaction, a particular site in the etherified compound obtained by the reaction above is halogenated in advance; a silyl group is introduced in reaction of the halide with a particular silane compound in the presence of n-BuLi, to give an organic silane compound (I) (see, for example, fourth to fifth reaction formulae in synthetic route 1, third to fourth reaction formulae in synthetic route 2, and third to fourth reaction formulae in synthetic route 3).

Typical examples of the method of preparing the organic silane compound (I) according to the present invention are shown below. Although synthetic routes by using a particular molecule containing a π-electron-conjugated skeleton is shown below, obviously, it is also possible to introduce a monovalent aliphatic hydrocarbon group A via an ether or thioether bond and a silyl group in the following synthetic routes even when other molecule containing a π-electron-conjugated skeleton is used.

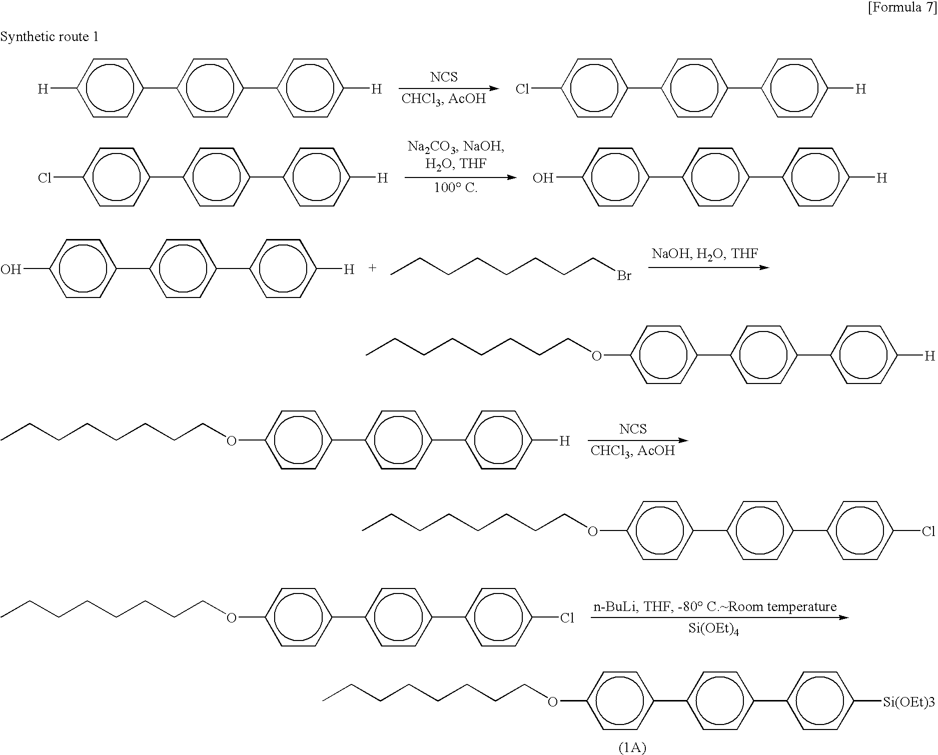

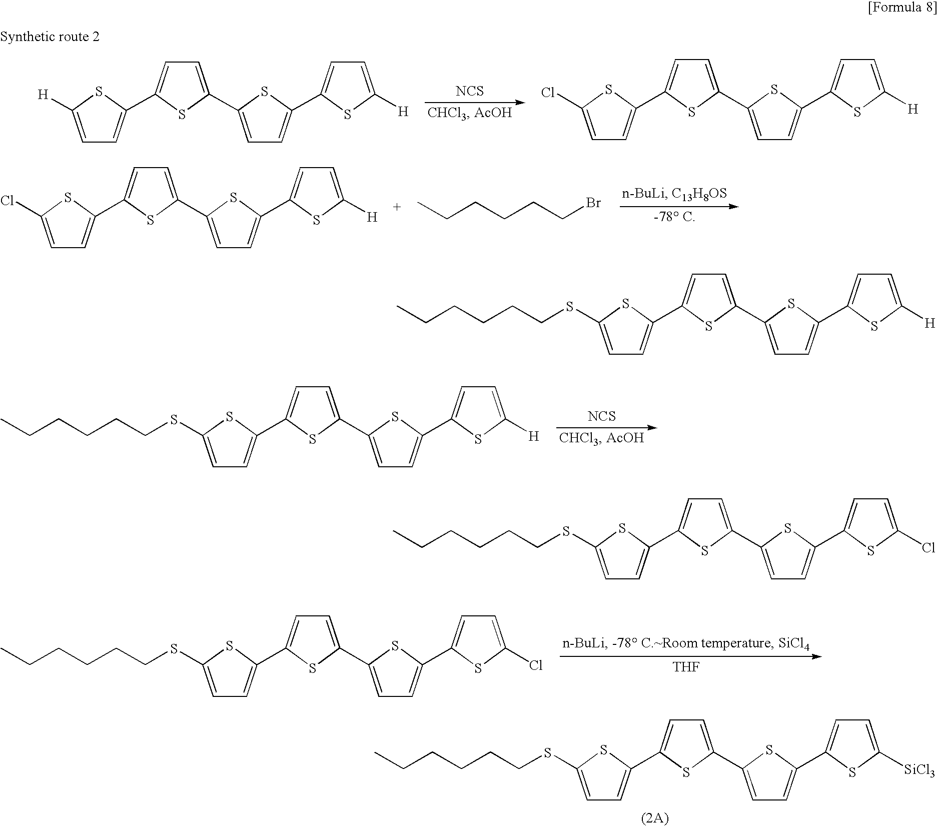

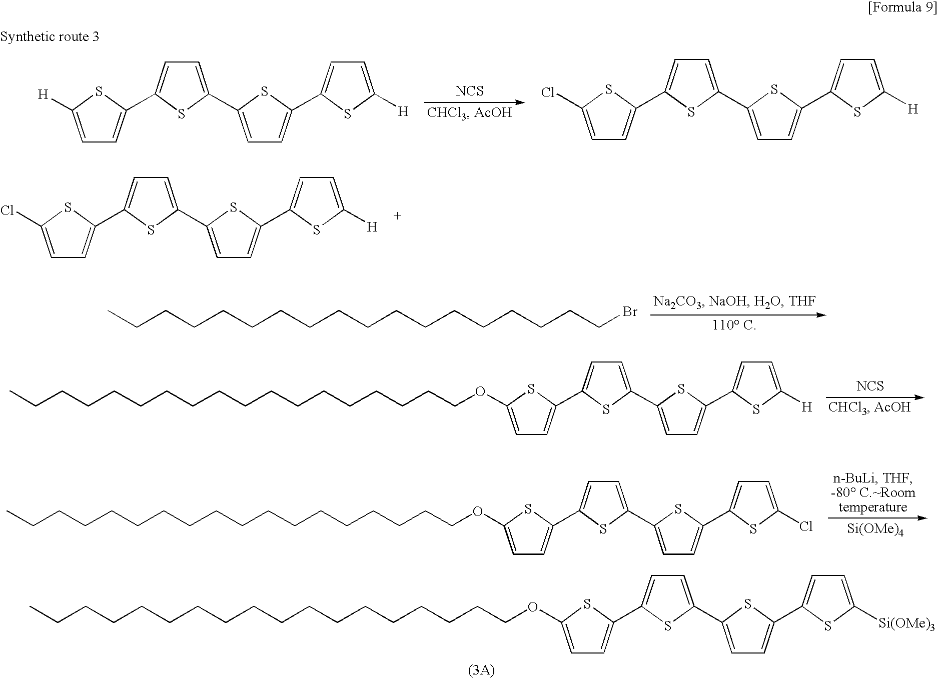

The organic silane compound (I) thus obtained may be isolated and purified by any one of known means such as resolubilization, concentration, solvent extraction, fractionation, crystallization, recrystallization, chromatography, and the like.

The molecule containing a π-electron-conjugated skeleton represented by the General Formula (III) for use in preparation of the organic silane compound (I) according to the present invention may be purchased as a commercial product or prepared by any one of known methods shown below.

Acene-Skeleton-Containing Molecule

The methods of preparing the acene-skeleton-containing molecule include, for example, (1) a method of repeating the steps of replacing the hydrogen atoms on two carbon atoms of a raw material compound at predetermined positions with ethynyl groups and binding the ethynyl groups to each other in ring-closure reaction, (2) a method of repeating the steps of substituting the hydrogen atoms on carbon atoms of a raw material compound at predetermined positions with triflate groups, allowing them to react with furan or the derivative thereof, and oxidizing the product, and the like. Examples of the methods of preparing an acene skeleton by these methods will be shown below.

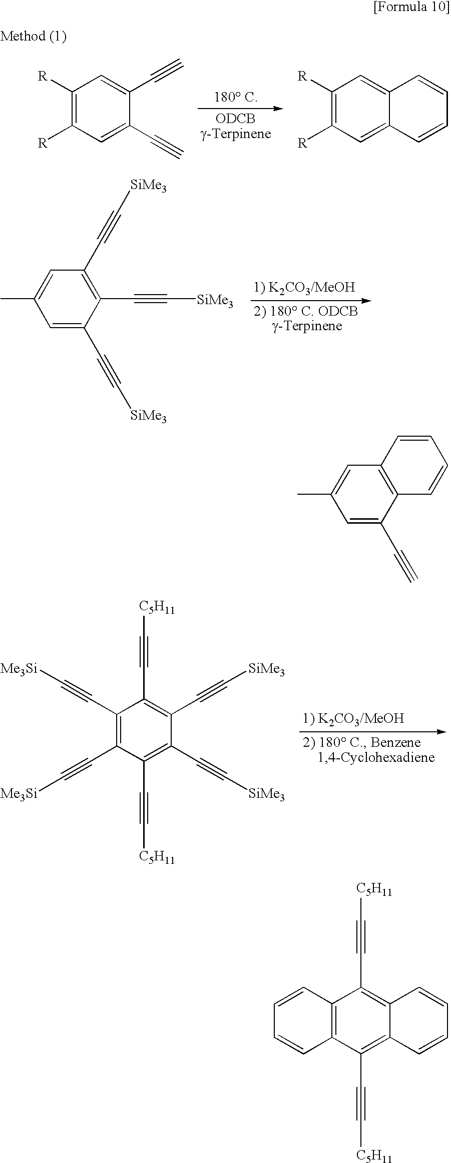

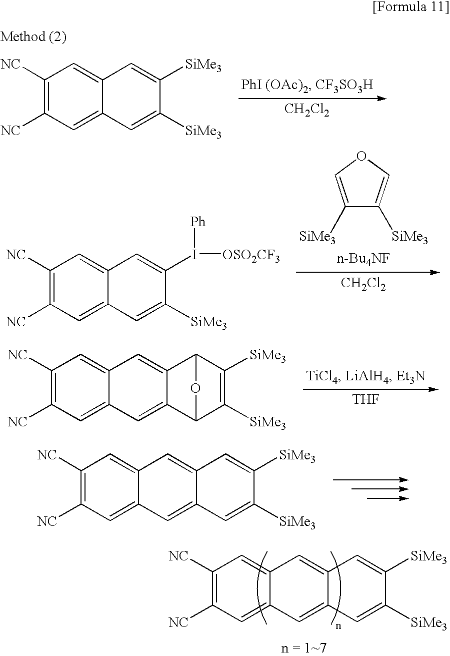

The method (2) is a method of increasing the number of benzene rings in the acene skeleton one by one, and thus, for example, it is possible to prepare an acene skeleton similarly even if the raw material compound contains a less reactive functional group or protecting group in a particular region. An example thereof is shown below.

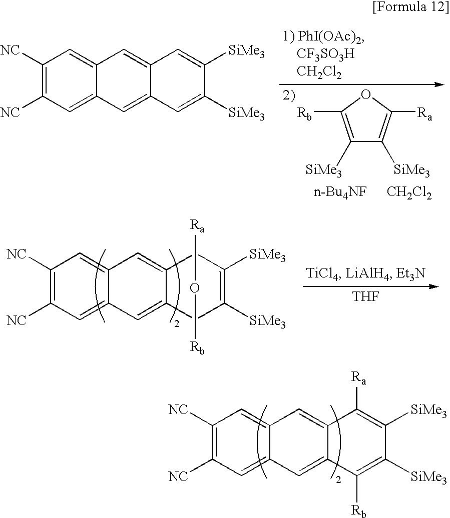

Ra and Rb each preferably represent a less reactive functional group or protecting group such as a hydrocarbon or ether group.

Also in the reaction formula of method (2), the starting compound having two acetonitrile groups and two trimethylsilyl groups may be replaced with a compound having four trimethylsilyl groups. In the reaction Formula above, reaction with a furan derivative and subsequent refluxing of the reaction product in the presence of lithium iodide and DBU (1,8-diazabicyclo[5.4.0]undec-7-ene) gives a compound having an additional benzene ring and two hydroxyl groups substituted from the starting compound.

Acenaphthene-Skeleton-Containing Molecule and Perylene-Skeleton-Containing Molecule

Acenaphthene-skeleton-containing molecules and perylene-skeleton-containing molecules can also be prepared according to a method similar to the method of producing the acene skeleton (1) (method (3)). An example of the production method is shown below.

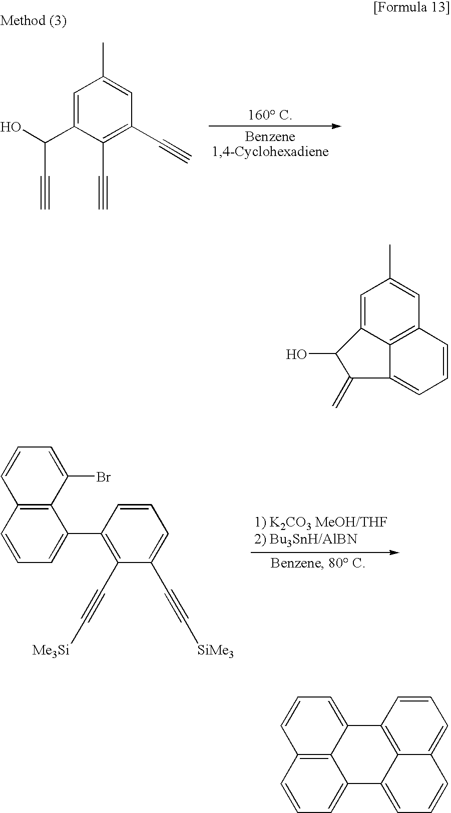

Molecule Containing a π-Electron-Conjugated Skeleton Used in Preparation of the Organic Silane Compound Represented by General Formula (1) (Y¹: S, O, or N)

Hereinafter, a preparative example for a thiophene-skeleton-containing molecule will be described. However, it is also possible to prepare molecules having an O or N-containing heterocyclic ring-skeleton, by using a method similar to that for the thiophene-skeleton-containing molecule.

Favorably in the method of preparing a thiophene-skeleton-containing molecule, a reactive site of thiophene is first halogenated, and then, Grignard reaction is used. It is thus possible to control the number of thiophene rings by the method. The compound can also be prepared by coupling with a metal catalyst (Cu, Al, Zn, Zr, Sn, or the like), instead of using the Grignard reagent.

In addition to the method of using the Grignard reagent, the thiophene-skeleton-containing molecule may be prepared by the following synthetic method.

Specifically, the 2′- or 5′-position of thiophene is first halogenated (for example, chlorinated). Thiophene is halogenated, for example, in reaction with one equivalence of N-chlorosuccinimide (NCS) or phosphorus oxychloride (POCl₃). The solvent for use then may be, for example, chloroform-acetic acid (AcOH) liquid mixture or DMF. The thiophene molecules can be bound to each other at the halogenated sites directly in reaction of the halogenated thiophene molecules in DMF solvent in the presence of a catalyst tris(triphenylphosphine)Nickel ((PPh₃)₃Ni).

Coupling of the halogenated thiophene with divinylsulfone give a 1,4-diketone derivative. Subsequently, reflux of a dry toluene solution is performed in the presence of Lawesson reagent (LR) or P₄S₁₀ overnight in the case of the former compound or for about three hours in case of the latter compound in order to lead to ring closure, giving a thiophene-skeleton-containing molecule with the number of thiophene rings increased by one than total number of thiophene rings in the coupled thiophene.

Thus, it is possible to increase the number of thiophene rings by using the reaction of thiophene above.

A method of preparing the thiophene-skeleton-containing molecule will be shown below as an example. Only reactions from thiophene dimer to tetramer and from thiophene trimer to 6- and 7-oligomers are shown in the following Preparative Examples. However, it is possible to form thiophene-skeleton-containing molecules other than the 4-, 6- or 7-oligomer in reaction with a thiophene-skeleton compound difference in unit number. For example, it is possible to form a thiophene pentamer by coupling of 2-chlorothiophene, chlorination of 2-chlorobithiophene with NCS after coupling, and subsequent reaction of the chlorinated product with 2-chlorinated derivative of thiophene trimer. In addition, chlorination of thiophene tetramer with NCS also leads to a 8- or 9-thiophene oligomer.

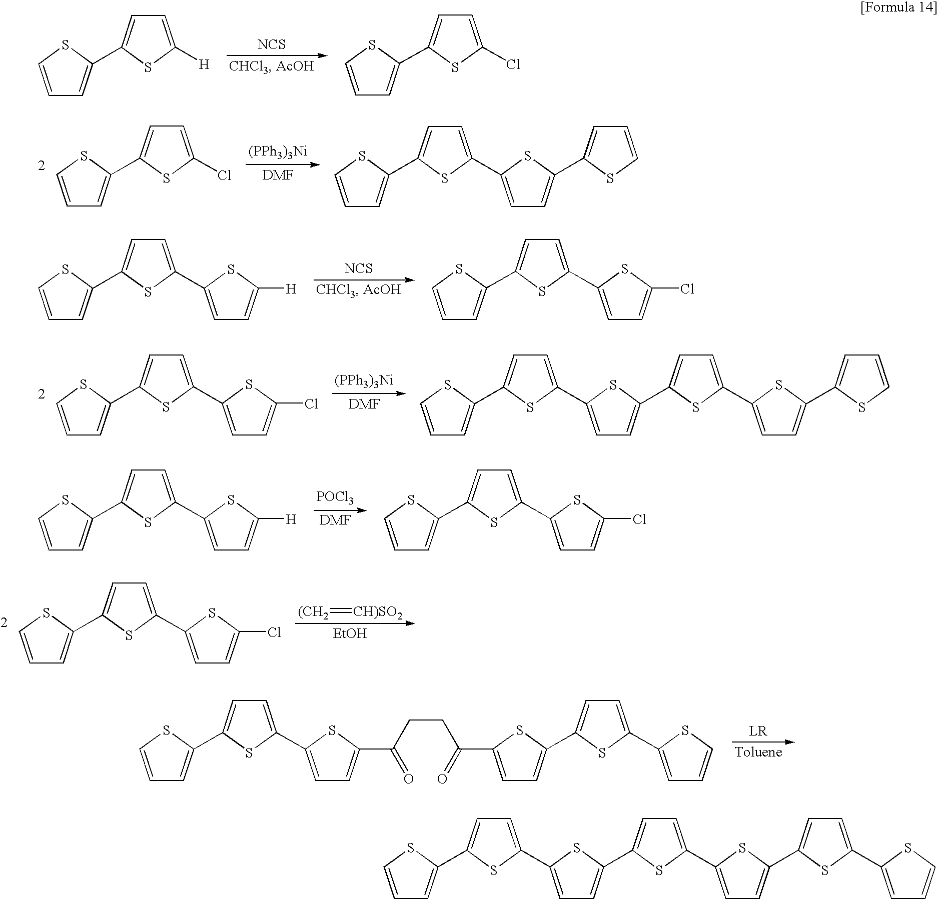

Molecule Containing a π-Electron-Conjugated Skeleton Used in Preparation of the Organic Silane Compound Represented by General Formula (1) (Y¹: Si, Ge, Se, Te, P, Sn, Ti, or Zr)

Hereinafter, a method of preparing a selenophene-skeleton-containing molecule or a silole-skeleton-containing molecule will be described. However, it is possible to prepare a molecule having a heterocyclic ring skeleton containing Ge, Te, P, Sn, Ti or Zr by using a method similar to that for these molecules.

Methods of preparing a selenophene-skeleton-containing molecule are reported in “Polymer (2003, 44, 5597-5603)”, and any one of the methods described in the report may be used in the present invention.

Methods of preparing a silole-skeleton-containing molecule are reported in “Journal of organometallic Chemistry (2002, 653, 223-228)”, “Journal of Organometallic Chemistry (1998, 559, 73-80)”, and “Coordination Chemistry Reviews (2003, 244, 1-44)”, and any one of the methods reported therein may be used in the present invention.

In particular in these methods, the number of the monocyclicheterocyclic ring (selenophene or silole ring) units can be controlled by repeating operations of halogenating a particular site in the heterocyclic unit-containing compound used as the starting material and performing Grignard reaction between the obtained halide and a Grignard reagent containing the unit.

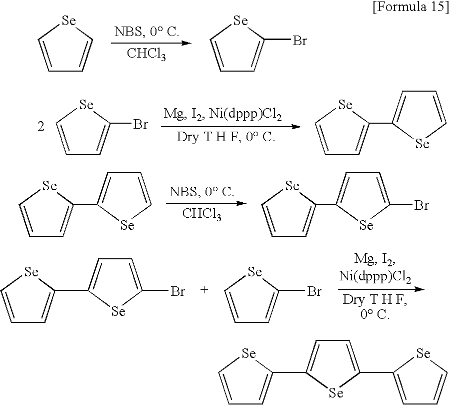

In the method above, reactions preparing selenophene dimer and trimer from its monomer are shown. It is possible to increase the number of selenophene rings one by one with the method above, and thus, to prepare a selenophene-skeleton-containing molecule of a tetramer or higher oligomer similarly by repeating the reaction.

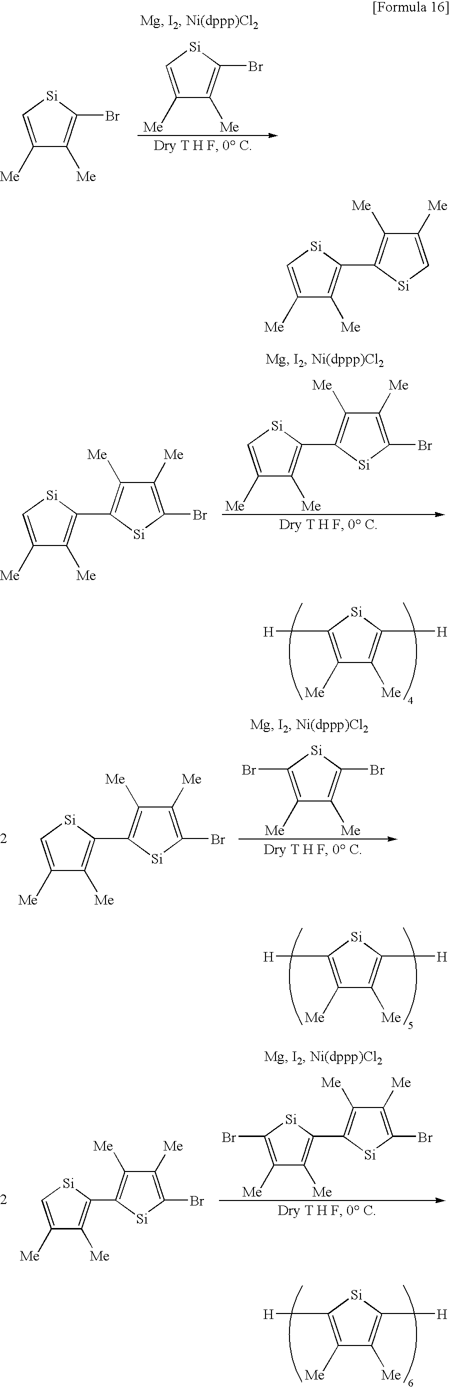

In the method above, shown are reactions of preparing silole dimer and tetramer to hexamer from its monomer. Also by the method, it is possible to increase the number of silole rings one by one and thus, to prepare a trimer or higher oligomer similarly by repeating the reaction. In the method above, bromination reaction is omitted. The bromination may be performed by a method similar to the bromination used in the method of preparing a selenophene-skeleton-containing molecule.

In addition to the method of using a Grignard reagent as described above, the selenophene- and silole-skeleton-containing molecules can be prepared by coupling with a suitable metal catalyst (Cu, Al, Zn, Zr, Sn, or the like), while the number of monocyclic heterocyclic units is controlled.

Molecule Containing a π-Electron-Conjugated Skeleton Used in Preparation of the Organic Silane Compound Represented by General Formula (3) (Y³: C, N, Si, Ge, P, Sn, Ti or Zr)

Hereinafter, the method of preparing a benzene-skeleton-containing molecule will be described. However, it is also possible to prepare a heterocyclic ring-skeleton-containing molecule containing N, Si, Ge, P, Sn, Ti or Zr by a method similar to that for the benzene-skeleton-containing molecule.

Favorably in the method of preparing a benzene-skeleton-containing molecule, a reactive site of benzene is first halogenated, and the halogenated derivative is allowed to react in Grignard reaction. It is possible to control the number of benzene rings by the method. In addition to use of the Grignard reagent, the compound is also prepared by coupling in the presence of a suitable metal catalyst (Cu, Al, Zn, Zr, Sn, or the like).

The method of preparing a benzene-skeleton-containing molecule will be shown below as an example. In the following preparative example, only a reaction from benzene trimer to a (3+m) oligomer is shown. However, it is possible to prepare oligomers of the benzene-skeleton-containing molecule other than the tetramer to heptamer above by using a starting material different in the number of units.

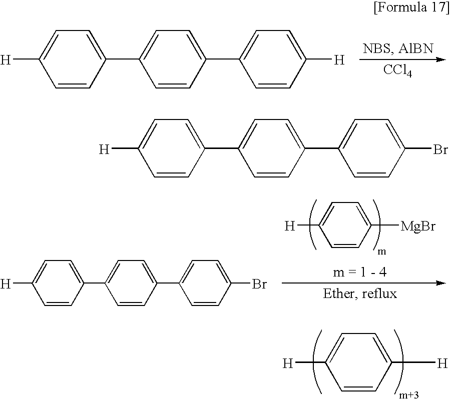

Molecule Containing a π-Electron-Conjugated Skeleton Used in Preparation of the Organic Silane Compound Represented by General Formula (5) (Y⁶, Y⁷, and Y⁸: S, N, O, Si, Ge, Se, Te, P, Sn, Ti, or Zr)

The block-type molecule containing a π-electron-conjugated skeleton (the compound represented by General Formula (5) with its silyl and A-B-groups substituted with H) for the organic silane compound represented by General Formula (5) can be prepared by preparing a block unit-containing compound and binding the compounds to each other. Examples of the binding methods include a method by using Suzuki coupling, a method by using Grignard reaction, and the like.

For example, in binding a thiophene-derived unit to both terminals of a compound having a silole ring, the compound having a silole ring is first debrominated and then borated by addition of n-BuLi and B(O-iPr)₃. The solvent for use then is preferably ether. The boration reaction is preferably a two-step process, and the first step is carried out at −78° C. for stabilization of the reaction in the early phase and the second step is carried out while the temperature is raised from −78° C. gradually to room temperature. Subsequently, a simple thiophene compound having a terminal halogen group (for example, bromine) and the borated compound above are allowed to react with each other, for example, in toluene solvent in the presence of Pd(PPh₃)₄ and Na₂CO₃ at a reaction temperature of 85° C. until completion of the reaction, giving a coupling product between them. Although use of a compound having a silole ring is described, a monocyclic heterocyclic compound containing S, N, O, Ge, Se, Te, P, Sn, Ti, or Zr as the hetero atom also has a reactivity at the 2,5-position similar to that of silole. Thus, it is also possible tobinda thiophene derived unit to both terminals of a monocyclic heterocyclic compound containing S, N, O, Ge, Se, Te, P, Sn, Ti, or Zr as the hetero atom, by a production method similar to that above. Although binding of a thiophene-derived unit is describe above, the thiophene-derived unit may be replaced with a unit derived from a monocyclic five-membered heterocyclic compound containing N, O, Si, Ge, Se, Te, P, Sn, Ti, or Zr as the hetero atom.

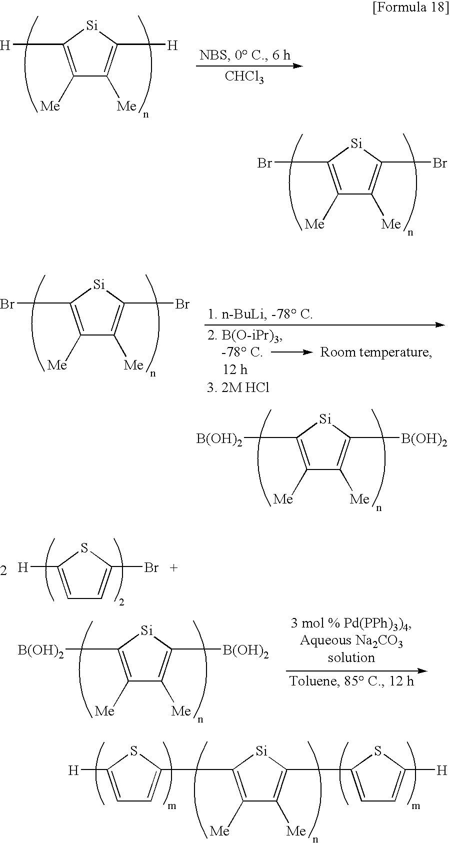

Molecule Containing a π-Electron-Conjugated Skeleton Used in Preparation of the Organic Silane Compound Represented by General Formula (6) (Y¹⁰: N, O, S, Si, Ge, Se, Te, P, Sn, Ti, or Zr; and Y⁹ and Y¹¹: N, C, Si, Ge, P, Sn, Ti, or Zr)

The block-typed molecule containing a π-electron-conjugated skeleton for the organic silane compound represented by General Formula (6) (the compound represented by General Formula (6) with its silyl group and group A-B substituted with H) can be prepared by a method similar to that for preparing the block-typed molecule containing a π-electron-conjugated skeleton for the organic silane compound represented by General Formula (5).

Specifically in binding a benzene-derived unit to both terminals of the compound having a silole ring, the compound having a silole ring is debrominated and then borated by addition of n-BuLi and B(O-iPr)₃. The solvent for use then is preferably ether. The boration reaction is preferably a two-step process, and the first step is carried out at −78° C. for stabilization of the reaction in the early phase and the second step is carried out while the temperature is raised from −78° C. gradually to room temperature. Subsequently, a simple benzene compound having a terminal halogen group (for example, bromine) and the borated compound above are allowed to react with each other, for example, in toluene solvent in the presence of Pd(PPh₃)₄ and Na₂CO₃ at a reaction temperature of 85° C. until completion of the reaction, giving a coupling product between them. Although use of a compound having a silole ring is described, a monocyclic heterocyclic compound containing S, N, O, Ge, Se, Te, P, Sn, Ti, or Zr as the hetero atom also has a reactivity similar to that of silole at the 2,5-position. Thus, it is also possible to bind a benzene-derived unit to both terminals of a monocyclic heterocyclic compound containing S, N, O, Ge, Se, Te, P, Sn, Ti, or Zr as the hetero atom by a production method similar to that above. Although binding of a benzene-derived unit is describe above, the benzene-derived unit may be replaced with a unit derived from a monocyclic six membered heterocyclic compound containing N, Si, Ge, P, Sn, Ti, or Zr as the hetero atom.

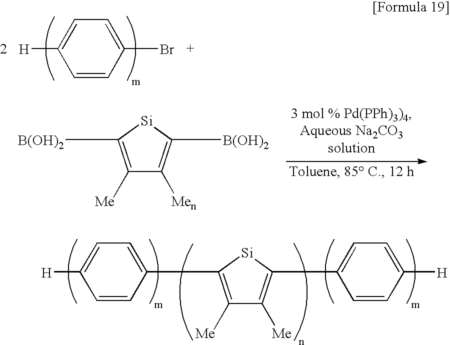

(Organic Thin Film and Method of Forming the Same)

The organic thin film according to the present invention has a unimolecular film formed by using an organic silane compound (I), preferably formed on a substrate.

The organic silane compound (I) has a hydrocarbon group A via an ether or thioether bond, and can be adsorbed (bound) on the substrate by chemical bonding of the silyl group (in particular, via silanol bonds (—Si—O—)). Thus in the unimolecular film of the organic silane compound (I), orientation of the organic group C is less influenced by orientation of the hydrocarbon group A, and, for example as shown in FIG. 1(A), the organic silane compound (I) molecule orients itself with its silyl group and hydrocarbon group A located respectively in the substrate and film-surface side. As a result, such a unimolecular film is superior in packing density and orientation (crystallinity) of the compound molecule as well as in peeling resistance, and can be formed easily by a solution process. Because the organic silane compound (I) contains π-electron-conjugated organic group C, the unimolecular film obtained is superior in electrical characteristics such as carrier-mobility efficiency when used as an organic layer (thin film) in an organic device such as organic thin film transistor, organic photoelectric conversion element, or organic electroluminescence element. In the present invention, such electrical characteristics are improved distinctively, because the unimolecular film has not only π-electron conjugation properties of the organic group C, but also high packing density and high orientation (crystallinity) of the molecule.

Examples of the raw materials for the substrate include element semiconductors such as silicon and germanium; compound semiconductors such as gallium arsenide and zinc selenide; quartz glass; and polymeric materials such as polyethylene, polyethylene terephthalate, and polytetrafluoroethylene. Alternatively, the substrate may be made of an inorganic material commonly used as the electrode of semiconductor device, which may have an organic material film additionally on the surface. The substrate in the present invention preferably has hydrophilic groups such as hydroxyl or carboxyl, in particular hydroxyl, on the surface, and the hydrophilic groups may be formed by hydrophilizing finishing of the surface of the substrate, if it does not have such groups. Hydrophilization of the substrate can be carried out, for example, by immersion of the substrate in a hydrogen peroxide-sulfuric acid mixed solution or by UV-light irradiation.

Hereinafter, the method of forming an organic thin film by using the organic silane compound (I) will be described. First in forming the organic thin film, the silyl group of an organic silane compound (I) is allowed to react with the surface of a substrate by hydrolysis, forming a unimolecular film adsorbed (bound) directly to the substrate. Specifically, a method such as so-called LB method (Langmuir Blodgett method), dipping method, or coating method may be used.

More specifically, for example in the LB method, an organic silane compound (I) is dissolved in a nonaqueous organic solvent, and the solution obtained is applied dropwise onto the surface of water previously pH-adjusted, forming a thin film thereon. The groups X¹ to X³ in the silyl group of the organic silane compound (I) are then hydrolyzed into hydroxyl groups. Subsequent application of pressure on the water surface in that state and withdrawal of the substrate with a surface carrying the hydrophilic groups formed (in particular, hydroxyl groups) leads to reaction of the silyl groups in the organic silane compound (I) with the substrate, giving a unimolecular film bound via chemical bonds (in particular, silanol bonds) to the substrate, as shown in FIG. 1(A). The pH of waster on which the solution is applied dropwise is preferably adjusted to a pH allowing hydrolysis of the groups X¹ to X³.

Alternatively, in the dipping method and the coating method, an organic silane compound (I) is dissolved in a nonaqueous organic solvent, and a substrate having hydrophilic groups (in particular, hydroxyl groups) on the surface is dipped in the solution obtained and then withdrawn therefrom, or the solution obtained is coated on the surface of the base material. The groups X¹ to X³ in the silyl group of the organic silane compound (I) are hydrolyzed then into hydroxyl groups by water present in a trace amount in the nonaqueous solvent. The silyl groups in the organic silane compound (I) are then bound to the substrate in reaction when the substrate is held as it is for a particular period, forming chemical bonds (in particular, silanol bonds) and consequently giving a unimolecular film shown in FIG. 1(A). When the groups X¹ to X³ are not hydrolyzed, it is preferable to add pH-adjusted water in a small amount to the solution.

The nonaqueous organic solvent is not particularly limited, if it is incompatible with water and dissolves the organic silane compound (I), and examples thereof include hexane, chloroform, carbon tetrachloride, and the like.

After the unimolecular film is formed, the unreacted organic silane compound on the unimolecular film is normally removed with a nonaqueous organic solvent. The film is washed with water and dried as it is left or heated.

In the unimolecular film according to the present invention, the layer of the group A in General Formula (1) can function as a protective film protecting the other molecule region. Thus, the top layer of the unimolecular film (i.e., oriented layered region of the aliphatic hydrocarbon group represented by A in Formula (1)) can function as a protective layer preventing oxidation and photodegradation of the regions beneath the layer.

The layer of the groups A, which crystallize by intermolecular interaction, is superior in gas permeability to amorphous materials.

The organic thin film obtained may be used directly as an electric material or may be processed additionally, for example, by electrolytic polymerization. Use of the organic silane compound (I) according to the present invention leads to formation of a Si—O—Si network in the organic thin film as shown in FIG. 1(A), decrease in the distance between neighboring molecules, and increase in orientation (crystallization).

Hereinafter, the organic silane compound, the functional organic thin film, and the methods of preparing the same will be described in more detail with reference to Examples.

### EXAMPLES

### Experimental Example 1

### Preparative Example 1

### Preparation of a Terphenyl Derivative Represented by General Formula (3) (A: n-octyl Group, B: Oxygen Atom, Y³: Carbon Atom, R: Hydrogen Atom, n1: 3, X¹, X², and X³: Ethoxy Group) (Hereinafter, Referred to as Terphenyl Derivative 1A (see Synthetic Route 1))

Commercially available terphenyl was used as the starting material and processed according to the synthetic route 1.

Terphenyl (cas No. 92-94-4; manufactured by Tokyo Chemical Industry Co. Ltd.) was dissolved in a solution of n-chlorosuccinimide, chloroform, and acetic acid, allowing chlorination of its terminal hydrogen. The solution in flask was stirred under a nitrogen environment, to give 4-chloroterphenyl. The 4-chloroterphenyl was dissolved in solution of sodium carbonate and sodium hydroxide in tetrahydrofuran (THF), and mixed with an excess amount of purified water. The solution was kept at 100° C. for hydroxylation of the chlorinated terminal. 4-Hydroxylterphenyl was added to and allowed to react in a solution of n-octyl bromide (111-25-1) and sodium hydroxide in THF and purified water, to perform etherification of the hydroxyl group in Williamson synthesis.

4-Octoxyterphenyl was chlorinated similarly to the reaction above. The product was terminal-triethoxysilylated in Grignard reaction. The desirable triethoxysilylated product was extracted with chloroform. The extract was dried over magnesium sulfate, and the product was recrystallized from methanol after removal of solvent. The product was purified additionally by silica gel by using chloroform as solvent.

The product was analyzed by ¹H-NMR for confirmation. The results are shown below:

7.5 to 7.3 (10H, m, phenylene), 6.8 (2H, m, phenylene), 3.9 (2H, m, octyl group), 3.8 (6H, m, ethoxy group), 1.7 to 1.3 (12H, m, octyl group), 1.2 (9H, m, ethoxy group), and 1.0 (3H, m, octyl group)

The product was also analyzed by IR measurement for confirmation. The results are shown below:

Si—C bond (690 cm⁻¹) and CO bond (1,110 cm⁻¹)

The results confirmed that the product was the title compound.

### Comparative Preparative Example 1

### Preparation of a Terphenyl Derivative Represented by General Formula (1B) (Hereinafter, Referred to as Terphenyl Derivative 1B)

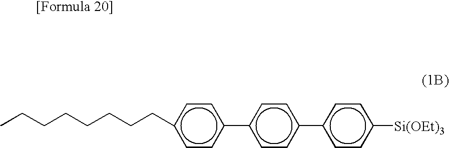

A terphenyl derivative 1B having no octyl group bound via an ether bond was prepared for comparison.

The synthetic method was the same as the method used in Preparative Example 1, except that Williamson synthesis was replaced with Grignard reaction.

### Example 1

Unimolecular simulation of the terphenyl derivatives 1A and 1B by a molecular orbital method revealed that the orientation angles thereof between the terphenyl skeleton and the octyl-group bond were respectively, 161 and 140 degrees. It was possible to expand the bond orientation angle by introduction of an ether bond, indicating that it was possible to expand the orientation direction of the octyl group in the film state.

### Example 2

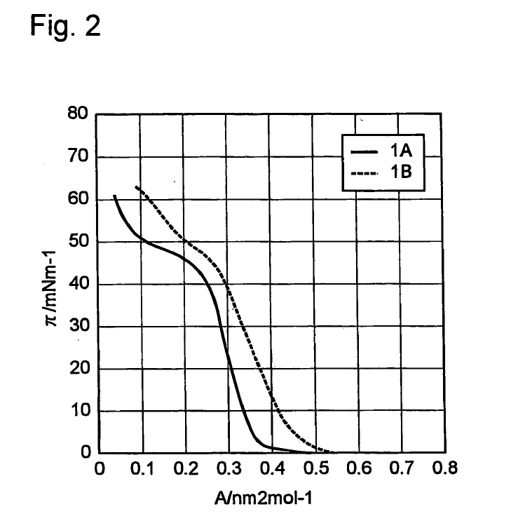

A unimolecular film of each of the terphenyl derivatives 1A and 1B was prepared by Langmuir-Blodgett (LB) method. The substrate used was a hydrophilized Si wafer. FIG. 2 shows the relationship between the surface pressure and molecular area of the film obtained by using water at pH 2 as a underlayer. The molecular area of the terphenyl derivative 1A estimated from the slope was 0.34 nm²·mol⁻¹, while that of the terphenyl derivative 1B was 0.47 nm²·mol⁻¹, greater than that of the terphenyl derivative 1A by approximately 0.13 nm²·mol⁻¹. Introduction of an ether bond resulted in decrease in molecular volume, indicating that the compound bound to an octyl group via an ether bond leads to shortening of the distance between neighboring molecules in the unimolecular film.

### Example 3

Each of the unimolecular films prepared was analyzed by X-ray diffraction by symmetrical reflection method. The measurement results revealed that the unimolecular film of the terphenyl derivative 1A showed distinct diffractions corresponding to face gaps of 0.454 nm, 0.386 nm, and 0.309 nm, while that of the terphenyl derivative 1B had broad diffractions corresponding to the gaps of 0.457 nm and 0.386 nm. The diffraction strength depends on the contents of the respective face gaps, and thus, the results show that the unimolecular film of the terphenyl derivative 1A has a periodic structure orderly formed.

The results above showed that it was possible to form a film having a densely-packed highly-oriented crystal structure by introducing an octyl group via an ether bond.

### Comparative Preparative Example 2

### Preparation of a Terphenyl Derivative Represented by General Formula (1C) (Hereinafter, Referred to as Terphenyl Derivative 1C)

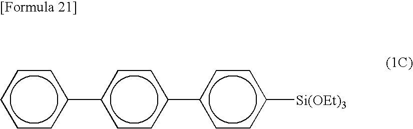

A terphenyl derivative 1C having none of the octyl and ether groups was prepared for comparison.

The synthetic method used was the Grignard reaction in Preparative Example 1.

### Example 4

The structural stability of the unimolecular films of terphenyl derivatives 1A and 1C was evaluated by electrical measurement. The film of terphenyl derivative 1C was prepared in a similar manner to the film in Example 2. The photoconductivity of the film was analyzed. In a similar manner to Example 2, a unimolecular film was formed on comb-tooth-shaped electrodes having a width of 200 μm respectively formed with gold and chromium in thicknesses of 30 and 20 nm by sputtering. The voltage-electric current characteristics when a 500-W Xe lamp was irradiated (bright) and not irradiated (dark) were evaluated, and the electric current flowing when a voltage of 50 V was applied was determined. The bright and dark currents immediately after preparation of the films of the terphenyl derivatives 1A and 1C were both 24 nA (bright current) and 140 pA (dark current). Measurement after storage of the film thus obtained in air for 30 days showed that the currents of the terphenyl derivative 1A were 21 nA (bright current) and 320 pA (dark current) while those of the terphenyl derivative 1C, 1 nA (bright current) and 340 pA (dark current). The large difference in bright current indicates that the terphenyl skeleton is under influence of oxidation in air. The terphenyl derivative 1A having an octyl group as its protecting group is less vulnerable to deterioration in properties.

A film was prepared by a different filming method shown below for evaluation of the adhesion between substrate and film caused by a silyl group. The adhesiveness of an unimolecular film of terphenyl derivative 1A prepared by a method similar to Example 2 and a film of terphenyl derivative 1C having a film thickness of approximately 10 nm prepared by vapor deposition was evaluated. Each of the films was cut into a lattice shape of 10 μm square with a cloth cutter; commercially available Kapton tape was bonded and then peeled off; and the appearance of the resulting film was evaluated by AFM. The appearance of the terphenyl derivative 1A film was not different form that before Kapton tape treatment, showing that a domain is formed, but the domain observed on the terphenyl derivative 1C vapor deposition film before treatment Kapton treatment was not observed after Kapton treatment. It seemed that the film was exfoliated by the Kapton treatment. The results indicate that the adhesive strength of the terphenyl derivative 1A film was increased. When the terphenyl derivative 1A is used in solution, the hydrolysis of the triethoxysilyl group is progressed; and thus, the reaction thereof with the hydroxyl group on the substrate surface is also progressed in order to from a film. The increase in adhesiveness of the terphenyl derivative 1A film is seemingly because the silanol bond between the silyl group and the substrate is formed more effectively.

### Experimental Example 2

### Preparative Example 2

Preparation of a Quaterthiophene Derivative Represented by General Formula (1) (A: N-Hexyl Group, B: Sulfur Atom, Y¹: Sulfur Atom, R: Hydrogen Atom, n1: 4, and X¹, X², and X³: Chlorine Atom) (Hereinafter, Referred to as Quaterthiophene Derivative 2A (See Synthetic Route 2))

Commercially available 2,2′-bithiophene was used as the starting material.

2,2′-Bithiophene (492-97-7; manufactured by Tokyo Chemical Industry Co. Ltd.) was treated with N-chlorosuccinimide (NCS) for chlorination, by using DMF as the solvent. The chlorobithiophene obtained was allowed to react directly with itself at the chlorinated site in DMF solvent in the presence of a catalyst tris(triphenylphosphine)nickel ((PPh₃)₃Ni), to give quaterthiophene.

Hereinafter, the quaterthiophene was further processed according to the synthetic route 2.

The quaterthiophene was dissolved in a solution of n-chlorosuccinimide, chloroform, and acetic acid, allowing chlorination of the terminal hydrogen. The solution in flask was stirred under a nitrogen environment, to give 2-chloro-quaterthiophene. The 2-chloro-quaterthiophene obtained was dissolved in a solution of n-butyllithium (109-72-8), thioxanthone (492-22-8), n-hexyl bromide in THF; and the solution was allowed to react in flask at −78° C., to give 2-hexylthio-quaterthiophene.

The 2-hexylthio-quaterthiophene was chlorinated in a similar manner to the reaction shown in Preparative Example 1. The product was terminal-trichlorosilylated in Grignard reaction. The desirable trichlorosilylated product was extracted with chloroform. The solution was dried over magnesium sulfate and, after removal of the solvent, the product was recrystallized from methanol. The product was further purified by silica gel by using chloroform as solvent.

The product was analyzed by ¹H-NMR for confirmation. The results are shown below:

7.0 (6H, m, thiophene ring), 6.9 (1H, m, thiophene ring), 6.8 (1H, m, thiophene ring), 2.9 (2H, m, hexyl group), 1.6 (2H, m, hexyl group), 1.3 (6H, m, hexyl group), and 1.0 (3H, m, hexyl group)

The product was also analyzed by IR measurement for confirmation. The results are shown below:

Si—C bond (690 cm⁻¹) and CO bond (1,110 cm⁻¹)

The results confirmed that the product was the title compound.

### Comparative Preparative Example 3

### Preparation of a Quaterthiophene Derivative Represented by General Formula (2B) (Hereinafter, Referred to as Quaterthiophene Derivative 2B)

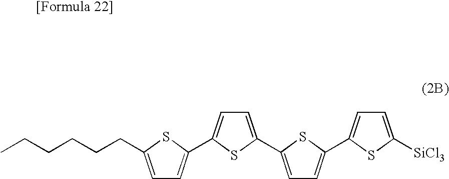

A quaterthiophene derivative 2B having no hexyl group bound via a thioether bond was prepared for comparison.

It was prepared in a similar manner to Preparative Example 2, except that hexylthiolation was omitted and coupling reaction of the hexyl groups was performed with a Grignard reagent.

### Example 5

Unimolecular simulation of the quaterthiophene derivatives 2A and 2B performed by a molecular orbital method revealed that the orientation angles thereof between the quaterthiophene skeleton and the hexyl-group bond were respectively 177 and 138 degrees. It was possible to expand the bond orientation angle by introduction of an ether bond, indicating that it was possible to expand the orientation direction of the hexyl group in the film state.

### Example 6

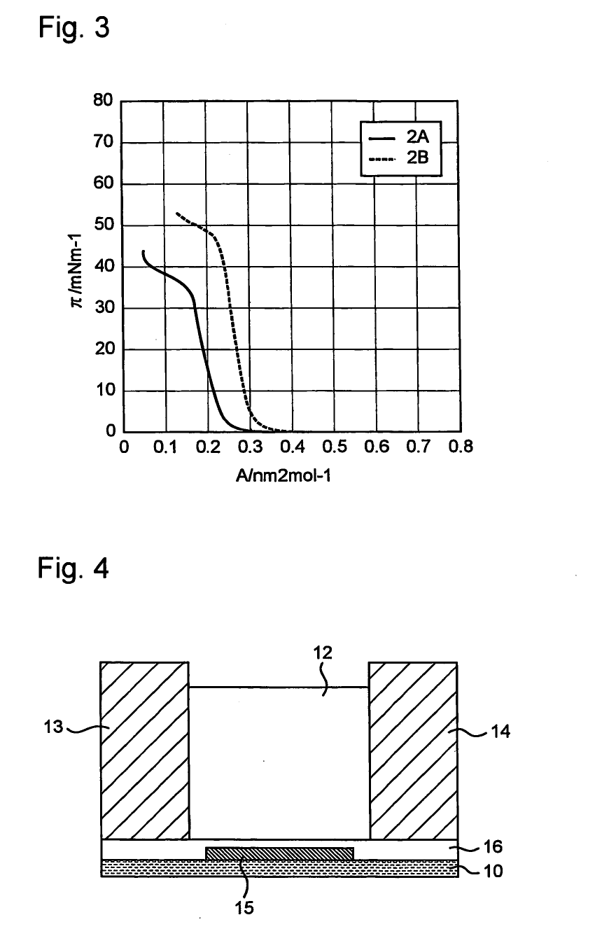

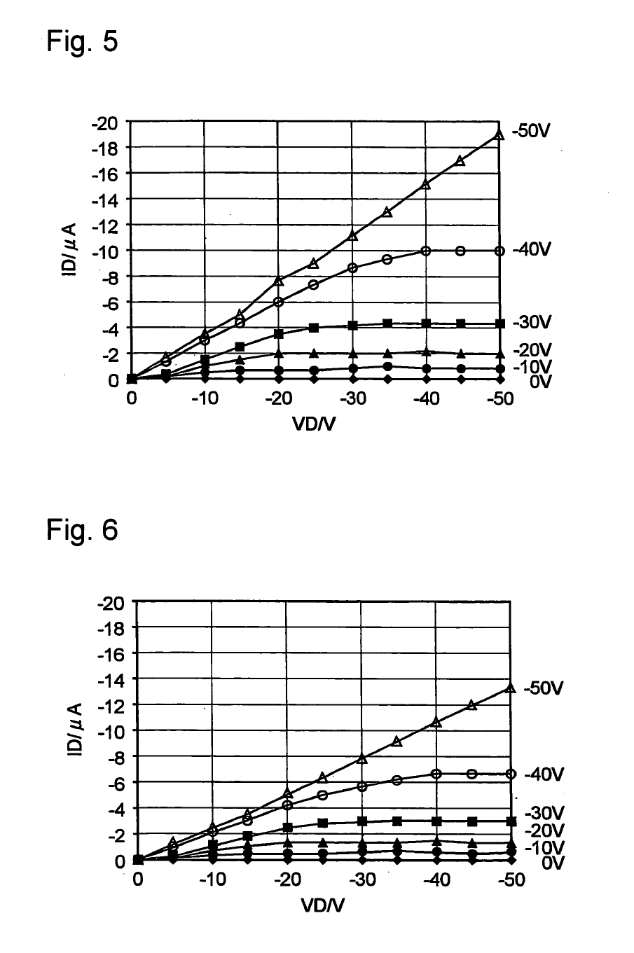

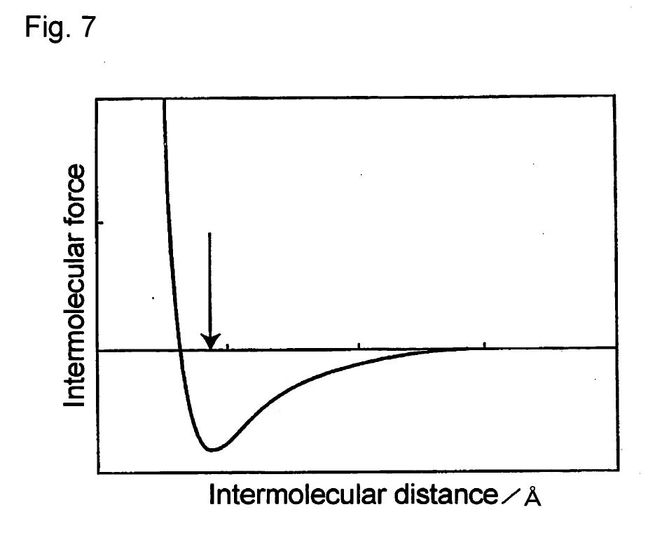

Unimolecular films were prepared by a method similar to that in Example 2 respectively by using the quaterthiophene derivatives 2A and 2B. FIG. 3 shows the relationship between the surface pressure and the molecular area of the film obtained by using water at pH 2 as a underlayer. The molecular area of the quaterthiophene derivative 2A estimated from the slope was 0.22 nm²·mol⁻¹, smaller by approximately 0.06 nm²·mol⁻¹ than that of the quaterthiophene derivative 2B of 0.28 nm²·mol⁻¹, indicating that the compound bound to an hexyl group via a thioether bond had a smaller molecular area in the film.

### Example 7

Unimolecular films of the quaterthiophene derivative 2A and 2B were formed for analysis by electron beam diffraction (ED). The substrate used was a copper mesh sheet carrying an immobilized Formval supporting film that was hydrophilized with SiO₂ formed by vapor deposition. A film was formed at a surface pressure of 25 mN·m⁻¹ by using the substrate prepared. The film formed was ED-analyzed under a transmission electron microscope, giving diffraction spots corresponding to the face gaps of 0.44 nm, 0.37 nm and 0.31 nm in the case of the quaterthiophene derivative 2A unimolecular film and diffraction rings corresponding to the face gaps of 0.45 nm, 0.38 nm and 0.32 nm in the ED image in the case of the quaterthiophene derivative 2B unimolecular film. Difference in the observed diffraction shape, spot or ring, indicates that the quaterthiophene derivative 2A unimolecular film is more oriented in the in-plane direction than the quaterthiophene derivative 2B unimolecular film. It is caused by the thioether bond formed.

The results by molecule simulation and crystal structure analysis described above indicated that the bond angle between the aliphatic hydrocarbon group A and the organic group C π-electron-conjugated unit region) widens and the film has the structure optimal for the π-electron conjugation system by introduction of the thioether bond.

### Comparative Preparative Example 4

### Preparation of a Quaterthiophene Derivative Represented by General Formula (2C) (Hereinafter, Referred to as Quaterthiophene Derivative 2C)

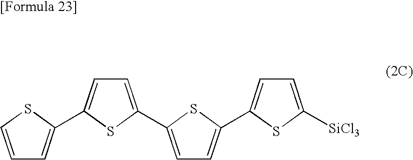

A quaterthiophene derivative 2C having none of octyl and ether groups was prepared for comparison.

The synthetic method used was the Grignard reaction in Preparative Example 2.

### Example 8

The structural stability of the unimolecular films of quaterthiophene derivatives 2A and 2C was evaluated by electrical measurement. The quaterthiophene derivative 2C unimolecular film was prepared in a similar manner to Example 2. The photoconductivity of the film was analyzed. In a similar manner to Example 2, a unimolecular film was formed on comb-tooth-shaped electrodes having a width of 200 μm respectively formed with gold and chromium in thicknesses of 30 and 20 nm by sputtering. The voltage-electric current characteristics when a 500-W Xe lamp was irradiated (bright) and not irradiated (dark) were evaluated, and the electric current flowing when a voltage of 50Vwas applied was determined. The bright and dark currents immediately after preparation of the films of quaterthiophene derivatives 2A and 2C were both 48 nA (bright current) and 330 pA (dark current). Measurement thereof after storage of the film prepared in air for 45 days showed that the currents of the quaterthiophene derivative 2A were 44 nA (bright current) and 380 pA (dark current) while those of the quaterthiophene derivative 2C, 10 nA (bright current) and 490 pA (dark current). The large difference in bright current indicates that the quaterthiophene skeleton is under influence of oxidation in air. The quaterthiophene derivative 2A having a hexyl group as its protecting group is less vulnerable to deterioration in properties.

The adhesiveness of the unimolecular film of quaterthiophene derivative 2A prepared by a method similar to Example 2 and the film of quaterthiophene derivative 2C having a film thickness of approximately 10 nm prepared by vapor deposition was evaluated. Each of the films was cut into a lattice shape of 10 μm square with a cloth cutter; commercially available Kapton tape was bonded and then peeled off; and the appearance of the film was evaluated by AFM. The appearance of the quaterthiophene derivative 2A film was not different form that before Kapton tape treatment, showing that a domain of several dozens μmφ was formed, but the domain observed on the quaterthiophene derivative 2C vapor deposition film before Kapton treatment was not observed after Kapton treatment. It seemed that the film was exfoliated by the Kapton treatment. The results indicate that the adhesive strength of the quaterthiophene derivative 2A film was increased. When the quaterthiophene derivative 2A is used in solution, the hydrolysis of the triethoxysilyl group is progressed; and thus, the reaction thereof with the hydroxyl group on the substrate surface is also progressed in order to from a film. The increase in the adhesive strength of the quaterthiophene derivative 2A film is seemingly because the silanol bond between the silyl group and the substrate is formed more effectively.

### Experimental Example 3

### Preparative Example 3

### Preparation of a Quaterthiophene Derivative Represented by General Formula (1) (A: n-Octadecyl Group, B: Oxygen Atom, Y¹ Sulfur Atom, R: Hydrogen Atom, n1: 4, X¹, X² and X³: Methoxy Group) (Hereinafter, Referred to as Quaterthiophene Derivative 3a (See Synthetic Route 3))

The quaterthiophene prepared in Preparative Example 2 was used as the starting material and processed according to the synthetic route 3.

The quaterthiophene was dissolved in a solution of n-chlorosuccinimide, chloroform, and acetic acid, allowing chlorination of its terminal hydrogen. The solution in flask was stirred under a nitrogen environment, to give 2-chloroquaterthiophene. The 2-chloroquaterthiophene obtained was dissolved in a solution of sodium carbonate and sodium hydroxide in tetrahydrofuran (THF), and the resulting solution was mixed with an excess amount of purified water. The solution was allowed to react at 110° C. for hydroxylation at the chlorinated terminal. The 2-hydroxylquaterthiophene was allowed to react in a solution of n-octadecyl bromide (111-83-1) and sodium hydroxide in THF and purified water while mixed, for etherification of the hydroxyl group in Williamson synthetic method. 2-Octadecyloxyquaterthiophene was chlorinated in a manner similar to the reaction shown in Preparative Example 1. The product was terminal-trichlorosilylated in Grignard reaction, and the desirable trichlorosilylated product was extracted with chloroform. The solution was dried over magnesium sulfate and, after removal of the solvent, the product was recrystallized from methanol. The product was further purified by silica gel by using chloroform as solvent.

The product was analyzed by ¹H-NMR for confirmation. The results are shown below:

7.0 (6H, m, thiophene ring), 6.5 (1H, m, thiophene ring), 6.0 (1H, m, thiophene ring), 3.9 (2H, m, octadecyl group), 3.6 (9H, m, methoxy group), 1.7 (2H, m, octadecyl group), 1.3 (30H, m, octadecyl group), and 1.0 (3H, m, octadecyl group)

The product was also analyzed by IR measurement for confirmation. The results are shown below:

Si—C bond (690 cm⁻¹) and CO bond (1,110 cm⁻¹)

The results confirmed that the product was the title compound.

### Comparative Preparative Example 5

### Preparation of a Quaterthiophene Derivative Represented by General Formula (3B) (Hereinafter, Referred to as Quaterthiophene Derivative 3B)

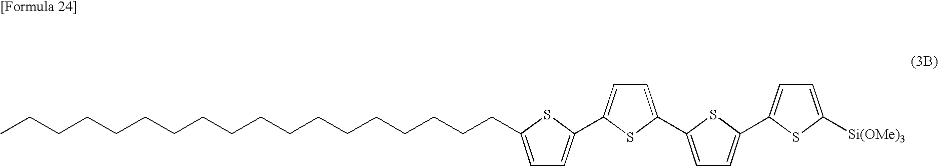

A quaterthiophene derivative 3B having none of octadecyl and ether groups was prepared for comparison.

The synthetic method was the same as the method in Preparative Example 3, except that the etherification reaction was eliminated and coupling reaction of octadecyl groups was performed with a Grignard reagent.

### Example 9

Unimolecular simulation of the quaterthiophene derivative 3A and 3B performed by a molecular orbital method revealed that the orientation angles thereof between the quaterthiophene skeletons and the octadecy-group bond were respectively 173 and 130 degrees. It was possible to expand the bond orientation angle by introduction of an ether bond, indicating that it was possible to expand the orientation direction of the octadecyl group in the film state.

### Example 10

Unimolecular films were formed respectively by using the quaterthiophene derivatives 3A and 3B by a method of immersing a substrate in solution. The solvent used was chloroform, and the concentration of the quaterthiophene derivative was 0.2 mM. A substrate Si wafer was surface-hydrophilized by immersing it in a solution of conc. sulfuric acid and hydrogen peroxide respectively at 7:3 vol %. The hydrophilized Si wafer was immersed in the solution prepared at room temperature for 24 hours. The substrate removed form the solution was ultrasonicated in chloroform and ethanol solvent for removal of residual compounds. The surface shape of the quaterthiophene derivative 3A and 3B films was analyzed by observation under an interatomic force microscope, showing a domain shape and thus indicating that a film is adsorbed. Increase in contact angle, as determined by using purified water, from 10 degrees before adsorption to 130 degrees indicates that the derivative is adsorbed on the substrate with its alkyl group oriented to the air interface side.

### Example 11

Each of the unimolecular films prepared in the Examples above was analyzed by X-ray diffraction. Each film showed the diffraction peak corresponding to a face gap of 0.41 nm derived from the hexagonal crystal structure of the octadecyl group. It also showed diffraction peaks derived from the quaterthiophene skeleton, and the face gaps determined from the respective diffraction peaks were 0.448, 0.378, and 0.311 nm for the quaterthiophene derivative 3A film and 0.460, 0.397, and 0.325 nm for the quaterthiophene derivative 3B film. The results showed that the octadecyl group and the quaterthiophene skeleton were crystallized in each film and that the quaterthiophene derivative 3A film was more densely packed than the quaterthiophene derivative 3B film although there was no difference in the packing state of the octadecyl group.

### Example 12

Chromium was vapor-deposited first on a silicon substrate 10, forming a gate electrode 15, for preparation of the organic thin film transistor shown in FIG. 4. Then, an insulation film 16 of silicon nitride was deposited thereon by plasma CVD; chromium and gold were vapor-deposited additionally in that order; and a source electrode 13 and a drain electrode 14 were formed by a normal lithographic method. The element prepared had channels having a width of 200 μm and a length of 1,000 mm, and the thickness of the insulation layer was 300 nm.

Subsequently, an organic semiconductor layer 12 of the quaterthiophene derivative 3A was formed on the substrate obtained according to the method shown in Example 10.

An organic thin film transistor was prepared in a similar manner to the above manner, except that the quaterthiophene derivative 3B was used.

The organic thin film transistors of the quaterthiophene derivative 3A and 3B obtained had electric-field-effect mobilities respectively of 1×10⁻¹ and 9×10⁻² cm²/Vs and on/off ratios of approximately 5 and 4 digits, and thus, the organic thin film transistor of quaterthiophene derivative 3A had more favorable properties than that of quaterthiophene derivative 3B. When voltage is applied from outside to the organic thin film transistor prepared, the quaterthiophene derivative 3A having a relatively smaller intermolecular distance in the quaterthiophene skeleton region allows easier hopping conduction of carrier and thus, increases the on-current. Specifically when the compound is turned on, the distance between neighboring molecules becomes smaller by interaction between induced dipoles, generating an environment favorable for hopping conduction and increasing the on current. It is also possible, when the molecule is turned off, to reduce the leakage current, because there is no direct covalent bonding between the π-electron conjugated skeletons (neighboring molecules) bound to Si atoms contained in the Si—O—Si two-dimensional network.

Thus, it is possible to provide an organic thin film having electric conductivity anisotropic in the molecular-axis direction and the direction perpendicular to the molecular plane and high crystallinity, by using the new substance according to the present invention.

### Experimental Example 4

### Preparative Example 4

### Preparation of a Terphenyl Derivative Represented by General Formula (3) (A: perfluoro-n-octyl Group, B: Oxygen Atom, Y³: Carbon Atom, R: Hydrogen Atom, n1: 3, X¹, X², and X³: Ethoxy Group) (Hereinafter, Referred to as Terphenyl Derivative 4A)

A terphenyl derivative 4A was prepared in a similar manner to Preparative Example 1, except that n-octyl bromide was replaced with perfluoro-n-octyl bromide and THF used in etherification of the hydroxyl group by Williamson synthetic method was replaced with carbon tetrachloride.

The product was analyzed by ¹H-NMR for confirmation. The results are shown below: 7.5 to 7.3 (10H, m, phenylene), 6.8 (2H, m, phenylene), 3.8 (6H, m, ethoxy group), and 1.2 (9H, m, ethoxy group)

The product was also analyzed by IR measurement for confirmation. The results are shown below:

Si—C bond (690 cm⁻¹) and CO bond (1,110 cm⁻¹) The results confirmed that the product was the title compound.

### Comparative Preparative Example 6

### Preparation of a Terphenyl Derivative Represented by General Formula (4B) (Hereinafter, Referred to as Terphenyl Derivative 4B)

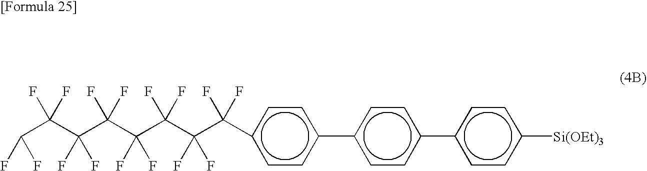

A terphenyl derivative 4B having no perfluorooctyl group bound via an ether bond was prepared for comparison.

The synthetic method was the same as the method in Preparative Example 4, except that the Williamson synthetic method was replaced with Grignard reaction.

### Example 13

Unimolecular simulation of the terphenyl derivative 4A and 4B by a molecular orbital method revealed that the orientation angles thereof between the terphenyl skeletons and the perfluorooctyl-group bond were respectively 168 and 133 degrees. It was possible to expand the bond orientation angle by introduction of an ether bond, indicating that it was possible to expand the orientation direction of the perfluorooctyl group in the film state.

### Example 14

The molecular area was determined by a method similar to that in Example 2, except that the terphenyl derivatives 4A and 4B were used. The molecular area of the terphenyl derivative 4A was 0.41 nm²·mol⁻¹, while that of the terphenyl derivative 4B was 0.53 nm²·mol⁻¹, greater than that of the terphenyl derivative 4A approximately by 0.12 nm²·mol⁻¹. Introduction of an ether bond resulted in decrease in molecular volume, indicating that the compound bound to a perfluorooctyl group via an ether bond lead to shortening of the distance between neighboring molecules in the unimolecular film.

### Example 15

Each of the unimolecular films prepared was analyzed by X-ray diffraction by symmetrical reflection method.

Measurement results confirmed that the terphenyl derivative 4A unimolecular film showed distinct diffraction corresponding to face gaps of 0.472 nm, 0.381 nm, an 0.315 nm, while the terphenyl derivative 4B unimolecular film, broad diffraction corresponding to face gaps of 0.451 nm and 0.371 nm. The diffraction strength depends on the contents of the respective face gaps, and thus, the results show that the unimolecular film of terphenyl derivative 4A had a periodic structure orderly formed.

The results above showed that it was possible to form a film having a densely-packed highly-oriented crystal structure by introducing a perfluorooctyl group via an ether bond.

### INDUSTRIAL APPLICABILITY

The organic silane compound (I) according to the present invention and the organic thin film using the same compound are useful for production of semiconductor electronic devices such as TFT, solar battery, fuel cell, and sensor.

1. A π-electron-conjugated organic silane compound represented by General Formula (I);
A-B—C—SiX¹X²X³ (1)
(wherein, A represents a monovalent aliphatic hydrocarbon group having 1 to 30 carbon atoms of which the hydrogen atoms may be replaced with halogen atoms; B represents an oxygen or sulfur atom; C represents a π-electron-conjugated bivalent organic group; and each of X¹ to X³ represents a group giving a hydroxyl group by hydrolysis).

2. The π-electron-conjugated organic silane compound according to claim 1, wherein the aliphatic hydrocarbon group A is a straight-chain group.

3. The π-electron-conjugated organic silane compound according to claim 1, wherein the organic group C contains one or more units selected from the group consisting of monocyclic aromatic ring units, fused aromatic ring units, monocyclic aromatic heterocyclic units, fused aromatic heterocyclic units, and unsaturated aliphatic units.

4. The π-electron-conjugated organic silane compound according to claim 1, wherein the organic group C contains one or more units selected from the group consisting of a benzene ring unit, a thiophene ring unit, and acene ring units.

5. The π-electron-conjugated organic silane compound according to claim 3, wherein the organic group C contains one to eight units connected to each other linearly.

6. A method of producing the π-electron-conjugated organic silane compound according to claim 1, comprising introducing a monovalent aliphatic hydrocarbon group A onto a molecule containing a π-electron-conjugated skeleton represented by General Formula (III):
H—C—H (III)
(wherein, C represents a π-electron-conjugated bivalent organic group) via an ether or thioether bond in Williamson reaction, and additionally introducing a silyl group in reaction thereof with a compound represented by General Formula (IV):
X⁴—SiX¹X²X³ (IV)
(wherein, each of X¹ to X³ represents a group giving a hydroxyl group by hydrolysis; and X⁴ represents a hydrogen or halogen atom or a lower alkoxy group).

7. A functional organic thin film, comprising a unimolecular film prepared by using the π-electron-conjugated organic silane compound according to claim 1.

8. The functional organic thin film according to claim 7, wherein the unimolecular film is formed on a substrate and the organic silane compound represented by General Formula (I) is present in the unimolecular film with its silyl group oriented to the substrate side and its group A to the film surface side.

9. The functional organic thin film according to claim 7, wherein the group A in General Formula (I) functions as a protective film protecting the region of the molecules other than the group A.

10. A method of producing a functional organic thin film, comprising forming a unimolecular film directly adsorbed on a substrate by hydrolyzing the silyl group in a π-electron-conjugated organic silane compound represented by General Formula (I);
A-B—C—SiX¹X²X³ (I)
(wherein, A represents a monovalent aliphatic hydrocarbon group having 1 to 30 carbon atoms of which the hydrogen atoms may be replaced with halogen atoms; B represents an oxygen or sulfur atom; C represents a π-electron-conjugated bivalent organic group; and each of X¹ to X³ represents a group giving a hydroxyl group by hydrolysis) and allowing the hydrolysate to react with the substrate surface, and washing and removing the unreacted organic silane compound remaining on the unimolecular film with a nonaqueous organic solvent.
